(19) United States
(12) Patent Application Publication
(10) Pub. No.: US 2026/0117078 A1
(43) Pub. Date: Apr. 30, 2026

(54) THREE-DIMENSIONAL PRINTING

(71) Applicants: Peridot Print LLC, Palo Alto, CA (US); Nanyang Technological University, Singapore (SG)

(72) Inventors: Jiayao CHEN, Singapore (SG); Kun ZHOU, Singapore (SG); Lihua ZHAO, Palo Alto, CA (US)

(73) Assignees: Peridot Print LLC, Palo Alto, CA (US); Nanyang Technological University, Singapore (SG)

(21) Appl. No.: 19/116,771

(22) PCT Filed: Sep. 30, 2022
(86) PCT No.: PCT/US2022/045450

§ 371 Date: Mar. 28, 2025

(51) Int. Cl. C09D 5/24; B29C 64/165; B29C 64/291; B29K 25/00; B29K 81/00; B29K 105/16; B29K 507/04; B33Y 10/00; B33Y 70/10; C09D 7/45; C09D 7/62; C09D 125/18; C09D 165/00

(52) U.S. Cl. CPC C09D 5/24; B29C 64/165; B29C 64/291; B33Y 10/00; B33Y 70/10; C09D 7/45; C09D 7/62; C09D 125/18; C09D 165/00; B29K 2025/06; B29K 2081/00; B29K 2105/162; B29K 2507/04

(57) ABSTRACT

An example of a multi-functional agent for three-dimensional (3D) printing includes carboxylated carbon nanotubes present in an amount ranging from about 0.5 wt % active to about 5.0 wt % active based on a total weight of the multi-functional agent; poly(3,4-ethylenedioxythiophene) polystyrene sulfonate (PEDOT:PSS) present in an amount ranging from about 0.1 wt % active to about 0.8 wt % active based on the total weight of the multi-functional agent; a co-solvent; and a balance of water.

### BACKGROUND

Three-dimensional (3D) printing is an additive manufacturing process used to make three-dimensional solid parts from a digital model. 3D printing techniques are considered additive manufacturing processes because they involve the application of successive layers of material (which, in some examples, may include build material, binder and/or other printing liquid(s), or combinations thereof). This is unlike traditional machining processes, which often rely upon the removal of material to create the final part. 3D printing is often used in rapid product prototyping, mold generation, mold master generation, and short run manufacturing for mass personalization and customization of goods.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram illustrating an example 3D printing technique;

FIG. 2 is a schematic diagram illustrating another example 3D printing technique;

FIG. 3 is a perspective view of a wearable device generated via the 3D printing technique described in FIG. 2;

FIG. 4 is a schematic illustration of the patterned build material layers that correspond with the cross-sectional view taken along line 4-4 of the wearable device of FIG. 3;

FIG. 5 is a graph depicting viscosity (mPa-s, Y axis) versus shear rates (s⁻¹, X axis) for an example of the multi-functional agent and the non-conductive agent disclosed herein;

FIG. 6 is a graph depicting stress (MPa, Y axis) versus stain (%, X axis) for 3D objects printed with an example of the multi-functional agent and/or the non-conductive agent disclosed herein;

FIG. 7 is a graph depicting stress (MPa, Y axis) versus stain (%, X axis) for 3D objects printed with different multi-functional agent dispensing times;

FIG. 8A through FIG. 8D are scanning electron microscope (SEM) images of 3D objects printed with dispensing times set forth in Table 4 of Example 2, where FIG. 8A depicts the 3D object printed with one multi-functional agent dispensing time, FIG. 8B depicts the 3D object printed with three multi-functional agent dispensing times, FIG. 8C depicts the 3D object printed with five multi-functional agent dispensing times, and FIG. 8D depicts the 3D object printed with seven multi-functional agent dispensing times;

FIG. 9 is a graph depicting the density (g/cm³, Y axis) of a 3D object versus the multi-functional agent dispensing time (#(see Table 4 in Example 2), X axis) used to print the 3D object;

FIG. 10 is a graph depicting the electrical conductivity (S/cm, Y axis) of a 3D object versus the multi-functional agent dispensing time used to print the 3D object;

FIG. 11 is a graph depicting the normalized resistance change (ΔR/R₀, Y axis, where ΔR is the change in resistance at any instance of deformation, and R₀ is the initial resistance) as a function of strain (%, X axis) for the 3D objects printed with different multi-functional agent dispensing times (1-8) during constant stretching;

FIG. 12 is a graph depicting the normalized resistance change (ΔR/R₀, Y axis) as a function of cycles (number, X axis) for a 3D object printed with one multi-functional agent dispensing time during cyclic stretch and release cycles; and

FIG. 13 is a graph depicting the normalized resistance change (ΔR/R₀, Y axis) as a function of time (seconds, X axis) for a strain sensor printed with an example of the multi-functional agent and non-conductive agent disclosed herein under periodic finger motions with different frequencies.

### DETAILED DESCRIPTION

The three-dimensional (3D) printing techniques disclosed herein utilize a multi-functional agent to pattern a polymeric build material composition. The multi-functional agent includes the combination of carboxylated carbon nanotubes and poly(3,4-ethylenedioxythiophene) polystyrene sulfonate (PEDOT:PSS). Together, the carboxylated carbon nanotubes and PEDOT:PSS serve as energy absorbers that enhance the absorption of infrared radiation, convert the absorbed radiation to thermal energy, and promote the transfer of the thermal heat to the build material composition in contact therewith. As such, when exposed to infrared radiation, the carboxylated carbon nanotubes and PEDOT:PSS sufficiently elevate the temperature of the polymer particles in the patterned build material composition to a temperature above the melting point or within the melting range of the polymer particles, allowing coalescing/fusing (e.g., thermal merging, melting, binding, etc.) of the build material composition to take place.

In addition to being infrared energy absorbers, the carboxylated carbon nanotubes and PEDOT:PSS are electrically conductive fillers and reinforcing fillers. As such, the multi-functional agent may be used to generate electrically conductive and mechanically strong components of 3D printed objects.

The multi-functional agent may be used alone to form an electrically conductive 3D object, or may be used in conjunction with non-conductive agent to form 3D objects with electrically conductive and electrically non-conductive components. In one example, the multi-functional agent and the non-conductive agent disclosed herein may be used to form a flexible printed article, examples of which include wearable devices, such as activity trackers, watches, etc., or any other device in which it is desirable for the electronics to be flexible.

Throughout this disclosure, a weight percentage that is referred to as “wt % active” refers to the loading of an active component of stock formulation that is present, e.g., in the multi-functional agent, detailing agent, etc. For example, an energy absorber, such as PEDOT:PSS, may be present in a water-based formulation (e.g., a stock solution or dispersion) before being incorporated into the vehicle of the multi-functional agent. In this example, the wt % actives of the PEDOT:PSS accounts for the loading (as a weight percent) of the PEDOT:PSS solids that are present in the multi-functional agent, and does not account for the weight of the other components (e.g., water, etc.) that are present in the stock solution or dispersion with the PEDOT:PSS. The term “wt %,” without the term actives, refers to the loading of a 100% active component that does not include other non-active components therein.

### Multi-Functional Agent

In the examples set forth herein, the multi-functional agent includes carboxylated carbon nanotubes; poly(3,4-ethylenedioxythiophene) polystyrene sulfonate (PEDOT:PSS); a co-solvent; and a balance of water. In some examples, the multi-functional agent consists of these components. In other examples, the multi-functional agent also includes a non-ionic surfactant.

Carbon nanotubes are cylinder-shaped allotropic forms of carbon. Carbon nanotubes may be single walled or multi-walled. In the examples disclosed herein, the carbon nanotubes are carboxylated. Carboxylated carbon nanotubes are carbon nanotubes that have been functionalized at the surface with carboxylic acid groups (—COOH). While any process resulting in carboxylation may be used, one example process involves exposing carbon nanotubes to reflux in concentrated sulfuric/nitric acid. The resulting carboxylated carbon nanotubes have from about 2 wt % to about 7 wt % COOH groups. Carboxylation renders the carbon nanotubes more hydrophilic.

The diameter of the carboxylated carbon nanotubes are on the nanoscale. In one example, the diameter ranges from about 0.5 nm to about 150 nm. In some examples, at least some of the carboxylated carbon nanotubes have a diameter ranging from about 0.5 nm to about 50 nm, in some examples from about 1 nm to about 25 nm, and in some examples from about 5 nm to about 20 nm. In an example, single-walled, carboxylated carbon nanotubes are used having a diameter ranging from about 0.5 nm to about 2 nm. In another example, multi-walled, carboxylated nanotubes are used having a diameter ranging from about 10 nm to about 150 nm.

The length of the carboxylated carbon nanotubes is greater than the diameter. In an example, the length is at least ten times the diameter. In one example, the diameter ranges from about 1 nm to about 200 μm. In some examples, at least some of the carboxylated carbon nanotubes have a length ranging from about 10 nm to about 100 μm, in some examples from about 50 nm to about 50 μm, and in some examples from about 100 nm to about 20 μm.

In one specific example, the diameter of the carboxylated carbon nanotubes ranges from about 50 nm to about 100 nm, and the length ranges from two times the diameter to less than 10 μm.

The carboxylated carbon nanotubes are present in an amount ranging from about 0.5 wt % active to about 5.0 wt % active based on a total weight of the multi-functional agent.

The carboxylated carbon nanotubes may be incorporated into the multi-functional agent in solid form (e.g., dried powder) or as part of a dispersion. A dispersion includes the carboxylated carbon nanotubes (e.g., from about 0.5 wt % to about 14 wt %) and water, and in some instances, a non-ionic surfactant. When the dispersion is used, it is to be understood that the other components (e.g., surfactant, water) become part of the multi-functional agent as well. Some commercially available carboxylated carbon nanotubes include those available from XFNANO Materials Tech. Co. Ltd. and those available from NanoLab Inc.

Poly(3,4-ethylenedioxythiophene) polystyrene sulfonate (PEDOT:PSS) is a polymer mixture of two ionomers. One component in this mixture is made up of sodium polystyrene sulfonate (PSS), and the other component is poly(3,4-ethylenedioxythiophene) (PEDOT). PSS is a sulfonated polystyrene that carries a negative charge. PEDOT is a conjugated polymer based on polythiophene that carries positive charges. Together, the PEDOT and PSS charged macromolecules form a macromolecular salt.

The PEDOT:PSS is present in an amount ranging from about 0.1 wt % active to about 0.8 wt % active based on the total weight of the multi-functional agent.

The PEDOT:PSS may be incorporated into the multi-functional agent in solid form (e.g., dried powder) or as part of a dispersion. A dispersion includes the PEDOT:PSS (e.g., from about 1 wt % to about 4 wt %) and water, and in some instances, a non-ionic surfactant. When the dispersion is used, it is to be understood that the other components (e.g., surfactant, water) become part of the multi-functional agent as well. PEDOT:PSS is commercially available from Sigma-Aldrich.

In an example, the total wt % active of the carboxylated carbon nanotubes and the PEDOT:PSS in the multi-functional agent is less than 5.0 wt % active. In one specific example, the carboxylated carbon nanotubes are present in an amount ranging from about 0.5 wt % active to about 5 wt % active based on the total weight of the multi-functional agent, and the PEDOT:PSS is present in an amount of about 0.25 wt % active based on the total weight of the multi-functional agent. In another specific example, the carboxylated carbon nanotubes are present in an amount ranging from about 0.5 wt % active to about 4.25 wt % active based on the total weight of the multi-functional agent, and the PEDOT:PSS is present in an amount of about 0.5 wt % active based on the total weight of the multi-functional agent. In yet another specific example, the carboxylated carbon nanotubes are present in an amount ranging from about 0.5 wt % active to about 3 wt % active based on the total weight of the multi-functional agent, and the PEDOT:PSS is present in an amount of about 0.75 wt % active based on the total weight of the multi-functional agent.

It is to be understood that when the carboxylated carbon nanotubes are present in a higher amount, e.g., from about 4 wt % active to about 5 wt % active, the PEDOT:PSS should be present in an amount of about 0.63 wt % active or less. Similarly, when the carboxylated PEDOT:PSS is present in a higher amount, e.g., from greater than 0.63 wt % active to about 0.8 wt % active, the carboxylated carbon nanotubes should be present in an amount of about 3 wt % active or less. Additionally, when smaller carboxylated carbon nanotubes are used (e.g., those having a diameter less than 50 nm), the higher amounts may be desirable.

The multi-functional agent also includes the co-solvent. Any water soluble or water miscible organic co-solvents may be used, such as aliphatic alcohols, aromatic alcohols, diols, glycol ethers, polyglycol ethers, lactams, formamides (substituted and unsubstituted), acetamides (substituted and unsubstituted), glycols, and long chain alcohols. Examples of these co-solvents include primary aliphatic alcohols, secondary aliphatic alcohols, 1,2-alcohols (e.g., 1,2-ethanediol, 1,2-propanediol, etc.), 1,3-alcohols (e.g., 1,3-propanediol), 1,5-alcohols (e.g., 1,5-pentanediol), 1,6-hexanediol or other diols (e.g., 2-methyl-1,3-propanediol, etc.), ethylene glycol alkyl ethers, propylene glycol, propylene glycol alkyl ethers, higher homologs (C₆-C₁₂) of polyethylene glycol alkyl ethers, diethylene glycol, triethylene glycol, tripropylene glycol methyl ether, tetraethylene glycol, glycerol, N-alkyl caprolactams, unsubstituted caprolactams, 2-pyrrolidone, 1-methyl-2-pyrrolidone, 1-(2-hydroxyethyl)-2-pyrrolidone, and the like. Other examples of organic co-solvents include dimethyl sulfoxide (DMSO), isopropyl alcohol, ethanol, pentanol, acetone, or the like.

The co-solvent(s) may be present in the multi-functional agent in a total amount ranging from about 1 wt % active to about 20 wt % active based upon the total weight of the multi-functional agent. In an example, the multi-functional agent includes from about 2 wt % active to about 15 wt % active, or from about 5 wt % active to about 10 wt % active of the co-solvent(s).

As mentioned, stock formulations containing the carboxylated carbon nanotubes or the PEDOT:PSS may include a non-ionic surfactant. An additional non-ionic surfactant may also be added to the multi-functional agent. Whether included as part of the stock formulation(s) or added as an additional ingredient, the non-ionic surfactant is present in a total amount ranging from about 0.1 wt % active to less than 5 wt % active based on the total weight of the multi-functional agent.

Examples of the non-ionic surfactant include polyvinyl pyrrolidone, alcohol ethoxylates, acetylenic diols, alkyl polyethylene oxides, alkyl phenyl polyethylene oxides, polyethylene oxide block copolymers, acetylenic polyethylene oxides, polyethylene oxide (di)esters, polyethylene oxide amines, dimethicone copolyols, substituted amine oxides, fluorosurfactants, and the like. Some specific examples of non-ionic surfactants include the following from Evonik Degussa: SURFYNOL® SEF (a self-emulsifiable, wetting agent based on acetylenic diol chemistry), SURFYNOL®440 or SURFYNOL® CT-111 (non-ionic ethoxylated low-foam wetting agents), SURFYNOL®420 (non-ionic ethoxylated wetting agent and molecular defoamer), SURFYNOL® 104E (non-ionic wetting agents and molecular defoamer), and TEGO® Wet 510 (organic surfactant). Other specific examples of non-ionic surfactants include the following from The Dow Chemical Company: TERGITOL™ TMN-6, TERGITOL™ 15-S-7, TERGITOL™ 15-S-9, TERGITOL™ 15-S-12 (secondary alcohol ethoxylates). Other suitable non-ionic surfactants are available from Chemours, including the CAPSTONE® fluorosurfactants, such as CAPSTONE® FS-35 (a non-ionic fluorosurfactant).

The balance of the multi-functional agent is water. In an example, deionized or another form of purified water may be used.

In one specific example, the multi-functional agent includes carboxylated carbon nanotubes present in an amount ranging from about 0.5 wt % active to about 5.5 wt % active based on a total weight of the multi-functional agent; poly(3,4-ethylenedioxythiophene) polystyrene sulfonate (PEDOT:PSS) present in an amount ranging from about 0.1 wt % active to about 0.8 wt % active based on the total weight of the multi-functional agent; a co-solvent; and a balance of water.

The multi-functional agent may be formed by combining carboxylated carbon nanotubes, poly(3,4-ethylenedioxythiophene) polystyrene sulfonate, a co-solvent, and water to form a mixture; sonicating the mixture for a predetermined amount of time; and filtering the mixture to remove aggregates of the carboxylated carbon nanotubes and the poly(3,4-ethylenedioxythiophene) polystyrene sulfonate that are greater than 1 μm. In an example, the mixture is sonicated, e.g., using ultrasonication, for a time ranging from about 30 minutes to about 60 minutes. Filtering may be performed with any filter having a pore size ranging from 1 μm to 5 μm. In one example method, sonicating and filtering are alternatingly performed for multiple cycles, such as from 3 cycles to 6 cycles.

After the final filtering cycle, the multi-functional agent includes from about 0.5 wt % active to about 5.5 wt % active, based on a total weight of the multi-functional agent, of carboxylated carbon nanotubes and from about 0.1 wt % active to about 0.8 wt % active, based on the total weight of the multi-functional agent, of poly(3,4-ethylenedioxythiophene) polystyrene sulfonate (PEDOT:PSS). Due, at least in part, to the filtering, the multi-functional agent is free of aggregates of the carboxylated carbon nanotubes and the PEDOT:PSS.

### Non-Conductive Agent

The multi-functional agent disclosed herein is used to create an electronic component of a 3D printed object. If the 3D printed object also includes non-conductive component(s), a non-conductive (i.e., not electrically conductive) agent may be used to patterned the build material composition that is to form the non-conductive component(s).

The non-conductive agent also includes an energy absorber, but the energy absorber is either not electrically conductive or is minimally electrically conductive (e.g., less than or equal to 10⁻⁵ S/cm) so that it imparts electrical insulating characteristics to the resulting component.

The energy absorber in the non-conductive agent may have substantial absorption (e.g., 80%) at least in the visible region (400 nm-780 nm) and in the infrared region (e.g., 800 nm to 4000 nm).

In some examples, the energy absorber may be an infrared light absorbing colorant. In an example, the energy absorber is a near-infrared light absorbing colorant. Any near-infrared colorants, e.g., those produced by Fabricolor, Eastman Kodak, or BASF, Yamamoto, may be used in the non-conductive agent. As one example, the non-conductive agent may be a printing liquid formulation including carbon black as the energy absorber. Examples of this printing liquid formulation are commercially known as CM997A, 516458, C18928, C93848, C93808, or the like, all of which are available from HP Inc.

As another example, the energy absorber in the non-conductive agent may be a near-infrared absorbing dye. Examples of printing liquid formulations including these types of dyes are described in U.S. Pat. No. 9,133,344, incorporated herein by reference in its entirety. Some examples of the near-infrared absorbing dye are water-soluble near-infrared absorbing dyes selected from the group consisting of:

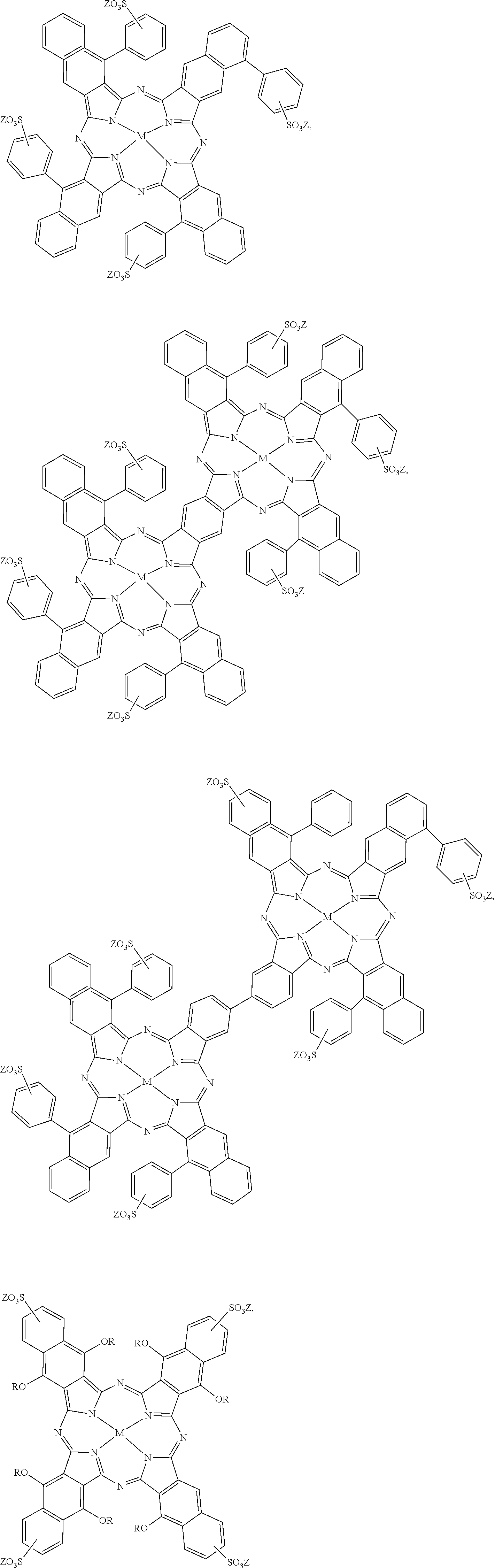

and mixtures thereof. In the above structures, M can be a divalent metal atom (e.g., copper, etc.) or can have OSO₃Na axial groups filling any unfilled valencies if the metal is more than divalent (e.g., indium, etc.), R can be hydrogen or any C₁-C₈ alkyl group (including substituted alkyl and unsubstituted alkyl), and Z can be a counterion such that the overall charge of the near-infrared absorbing dye is neutral. For example, the counterion can be sodium, lithium, potassium, NH₄⁺, etc.

Some other examples of the near-infrared absorbing dye are hydrophobic near-infrared absorbing dyes selected from the group consisting of:

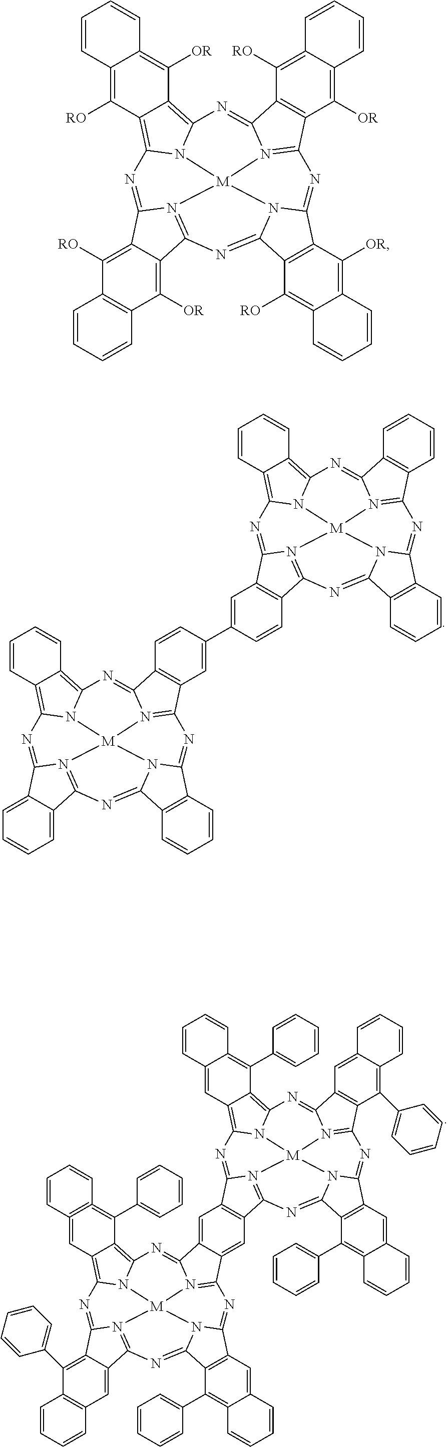

and mixtures thereof. For the hydrophobic near-infrared absorbing dyes, M can be a divalent metal atom (e.g., copper, etc.) or can include a metal that has Cl, Br, or OR′ (R′=H, CH₃, COCH₃, COCH₂COOCH₃, COCH₂COCH₃) axial groups filling any unfilled valencies if the metal is more than divalent, and R can be hydrogen or any C₁-C₈ alkyl group (including substituted alkyl and unsubstituted alkyl).

Other near-infrared absorbing dyes or pigments may be used. Some examples include anthraquinone dyes or pigments, metal dithiolene dyes or pigments, cyanine dyes or pigments, perylenediimide dyes or pigments, croconium dyes or pigments, pyrilium or thiopyrilium dyes or pigments, boron-dipyrromethene dyes or pigments, or aza-boron-dipyrromethene dyes or pigments.

Anthraquinone dyes or pigments and metal (e.g., nickel) dithiolene dyes or pigments may have the following structures, respectively:

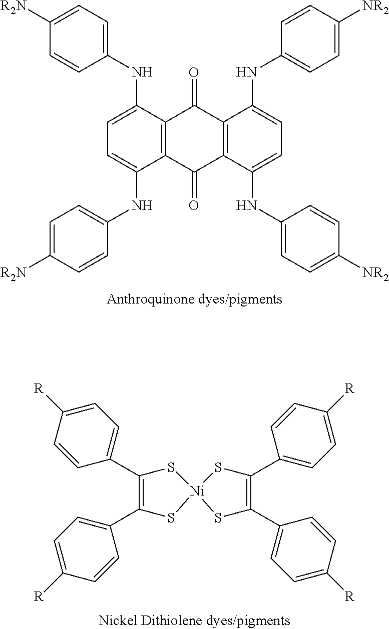

where R in the anthraquinone dyes or pigments may be hydrogen or any C₁-C₈ alkyl group (including substituted alkyl and unsubstituted alkyl), and R in the dithiolene may be hydrogen, COOH, SO₃, NH₂, any C₁-C₈ alkyl group (including substituted alkyl and unsubstituted alkyl), or the like.

Cyanine dyes or pigments and perylenediimide dyes or pigments may have the following structures, respectively:

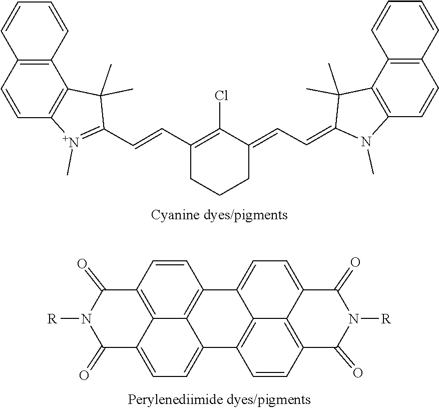

where R in the perylenediimide dyes or pigments may be hydrogen or any C₁-C₈ alkyl group (including substituted alkyl and unsubstituted alkyl).

Croconium dyes or pigments and pyrilium or thiopyrilium dyes or pigments may have the following structures, respectively:

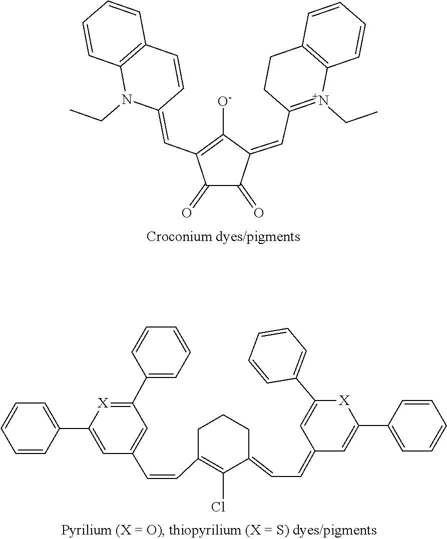

Boron-dipyrromethene dyes or pigments and aza-boron-dipyrromethene dyes or pigments may have the following structures, respectively:

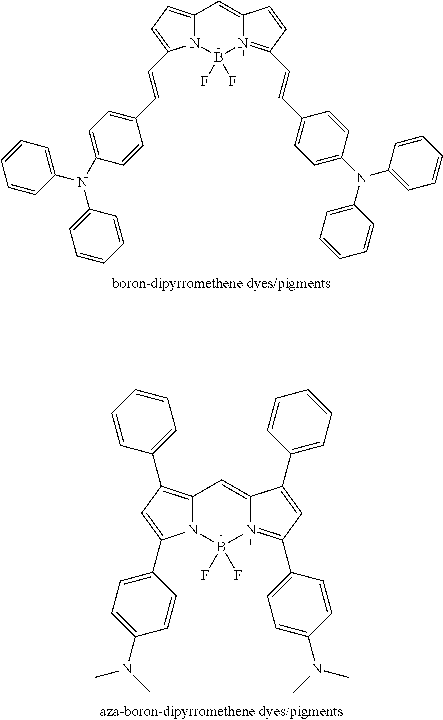

The amount of the energy absorber that is present in the non-conductive agent ranges from greater than 0 wt % active to about 40 wt % active based on the total weight of the non-conductive agent. In other examples, the amount of the energy absorber in the non-conductive agent ranges from about 0.3 wt % active to 30 wt % active, from about 1 wt % active to about 20 wt % active, from about 1.0 wt % active up to about 10.0 wt % active, or from greater than 4.0 wt % active up to about 15.0 wt % active. It is believed that these energy absorber loadings provide a balance between the non-conductive agent having jetting reliability and heat and/or radiation absorbance efficiency.

The energy absorber is dispersed or dissolved in an aqueous or non-aqueous vehicle. In some examples, the vehicle may include water alone or a non-aqueous solvent alone, i.e., with no other components. In other examples, the vehicle may include other components, depending, in part, upon the applicator that is to be used to dispense the non-conductive agent. Examples of other suitable non-conductive agent components include co-solvent(s), humectant(s), surfactant(s), anti-microbial agent(s), anti-kogation agent(s), chelating agent(s), buffer(s), and/or combinations thereof.

Any of the water soluble or water miscible organic co-solvents set forth herein for the multi-functional agent may be used in the non-conductive agent. The co-solvent(s) may be present in the non-conductive agent in a total amount ranging from about 1 wt % active to about 20 wt % active based upon the total weight of the non-conductive agent. In an example, the non-conductive agent includes from about 2 wt % active to about 15 wt % active, or from about 5 wt % active to about 10 wt % active of the co-solvent(s).

The vehicle may also include humectant(s). An example of a suitable humectant is ethoxylated glycerin having the following formula:

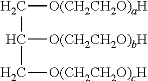

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

In an example, the total amount of the humectant(s) present in the non-conductive agent ranges from about 3 wt % active to about 10 wt % active, based on the total weight of the non-conductive agent.

The vehicle may also include surfactant(s). Suitable surfactant(s) include non-ionic or anionic surfactants. Any of the non-ionic surfactants set forth herein for the multi-functional agent may be used. Some specific examples of anionic surfactants include alkyldiphenyloxide disulfonate (e.g., the DOWFAX™ series, such a 2A1, 3B2, 8390, C6L, C10L, and 30599, from The Dow Chemical Company), docusate sodium (i.e., dioctyl sodium sulfosuccinate), sodium dodecyl sulfate (SDS).

Whether a single surfactant is used or a combination of surfactants is used, the total amount of surfactant(s) in the non-conductive agent may range from about 0.01 wt % active to about 3 wt % active based on the total weight of the non-conductive agent. In an example, the total amount of surfactant(s) in the non-conductive agent may be about 1 wt % active based on the total weight of the non-conductive agent.

The vehicle may also include anti-microbial agent(s). Anti-microbial agents are also known as biocides and/or fungicides. Examples of suitable anti-microbial agents include the NUOSEPT® (Ashland Inc.), UCARCIDE™ or KORDEK™ or ROCIMA™ (The Dow Chemical Company), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (The Dow Chemical Company), and combinations thereof.

In an example, the total amount of anti-microbial agent(s) in the non-conductive agent ranges from about 0.01 wt % active to about 0.05 wt % active (based on the total weight of the non-conductive agent). In another example, the total amount of anti-microbial agent(s) in the non-conductive agent is about 0.04 wt % active (based on the total weight of the non-conductive agent).

The vehicle may also include anti-kogation agent(s), e.g., when the non-conductive agent is to be jetted using thermal inkjet printing. Kogation refers to the deposit of dried printing liquid (e.g., non-conductive agent) on a heating element of a thermal inkjet printhead. Anti-kogation agent(s) is/are included to assist in preventing the buildup of kogation.

Examples of suitable anti-kogation agents include oleth-3-phosphate (commercially available as CRODAFOS™ O3A or CRODAFOS™ N-3A) or dextran 500 k. Other suitable examples of the anti-kogation agents include CRODAFOS™ HCE (phosphate-ester from Croda Int.), CRODAFOS® O10A (oleth-10-phosphate from Croda Int.), or DISPERSOGEN® LFH (polymeric dispersing agent with aromatic anchoring groups, acid form, anionic, from Clariant), etc. It is to be understood that any combination of the anti-kogation agents listed may be used.

The anti-kogation agent may be present in the non-conductive agent in an amount ranging from about 0.1 wt % active to about 1.5 wt % active, based on the total weight of the non-conductive agent. In an example, the anti-kogation agent is present in an amount of about 0.5 wt % active, based on the total weight of the non-conductive agent.

Chelating agents (or sequestering agents) may be included in the liquid vehicle of the non-conductive agent to eliminate the deleterious effects of heavy metal impurities. In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

Whether a single chelating agent is used or a combination of chelating agents is used, the total amount of chelating agent(s) in the non-conductive agent may range from greater than 0 wt % active to about 0.5 wt % active based on the total weight of the non-conductive agent. In an example, the chelating agent is present in an amount ranging from about 0.05 wt % active to about 0.2 wt % active based on the total weight of non-conductive agent. In another example, the chelating agent(s) is/are present in the non-conductive agent in an amount of about 0.05 wt % active (based on the total weight of the non-conductive agent).

Some examples of the non-conductive agent include a buffer. The buffer may be TRIS (tris(hydroxymethyl)aminomethane or TRIZMA®), TRIS or TRIZMA® hydrochloride, bis-tris propane, TES (2-[(2-Hydroxy-1,1-bis(hydroxymethyl)ethyl)amino]ethanesulfonic acid), MES (2-ethanesulfonic acid), MOPS (3-(N-morpholino)propanesulfonic acid), HEPES (4-(2-hydroxyethyl)-1-piperazineethanesulfonic acid), DIPSO (3-(N,N-Bis[2-hydroxyethyl]amino)-2-hydroxypropanesulfonic acid), Tricine (N-[tris(hydroxymethyl)methyl]glycine), HEPPSO (β-Hydroxy-4-(2-hydroxyethyl)-1-piperazinepropanesulfonic acid monohydrate), POPSO (Piperazine-1,4-bis(2-hydroxypropanesulfonic acid) dihydrate), EPPS (4-(2-Hydroxyethyl)-1-piperazinepropanesulfonic acid, 4-(2-Hydroxyethyl)piperazine-1-propanesulfonic acid), TEA (triethanolamine buffer solution), Gly-Gly (Diglycine), bicine (N,N-Bis(2-hydroxyethyl)glycine), HEPBS (N-(2-Hydroxyethyl)piperazine-N′-(4-butanesulfonic acid)), TAPS ([tris(hydroxymethyl)methylamino]propanesulfonic acid), AMPD (2-amino-2-methyl-1,3-propanediol), TABS (N-tris(Hydroxymethyl)methyl-4-aminobutanesulfonic acid), or the like.

In an example, the total amount of buffer(s) in the non-conductive agent ranges from about 0.01 wt % to about 3 wt % (based on the total weight of the non-conductive agent).

The balance of the non-conductive agent is water (e.g., deionized water, purified water, etc.). The amount of water may vary depending upon the amounts of the other components in the non-conductive agent. In one example, the non-conductive agent is jettable via a thermal inkjet printhead, and includes from about 50 wt % to about 90 wt % water.

### Build Material Composition

The build material composition includes a polymeric material. Any polymeric material may be used that can be 3D printed in the examples set forth herein and that impart desired properties (e.g., bendability) to the resulting 3D object. Examples of suitable polymeric materials include a polyamide (PAs) (e.g., PA 11/nylon 11, PA 12/nylon 12, PA 6/nylon 6, PA 8/nylon 8, PA 9/nylon 9, PA 66/nylon 66, PA 612/nylon 612, PA 812/nylon 812, PA 912/nylon 912, etc.), a thermoplastic polyamide (TPA), a thermoplastic polyurethane (TPU), polyethylene terephthalate, polybutylene terephthalate, polystyrene, polypropylene, high density polyethylene, polyetherketone, polyether ether ketone, polyetherketoneketone, and a combination thereof. When the 3D object is to be bendable, any of the thermoplastic elastomers may be selected as the polymeric material in the build material composition.

In some examples, the polymeric material may be in the form of a powder. In other examples, the polymeric material may be in the form of a powder-like material, which includes, for example, short fibers having a length that is greater than its width. In some examples, the powder or powder-like material may be formed from, or may include, short fibers that may, for example, have been cut into short lengths from long strands or threads of material.

The polymeric material may be made up of similarly sized particles and/or differently sized particles. In an example, the average particle size of the polymeric material ranges from about 2 μm to about 225 μm. In another example, the average particle size of the polymeric material ranges from about 10 μm to about 130 μm. As used herein, the term “average particle size” refers to the average diameter of the particles. In an example, a particle distribution (D10 to D90) ranges from about 30 μm to about 125 μm with a median diameter of about 60 μm (D50).

When the polymeric material is a polyamide, the polymer may have a wide processing window of greater than 5° C., which can be defined by the temperature range between the melting point and the re-crystallization temperature. In an example, the polymer may have a melting point ranging from about 50° C. to about 300° C. As other examples, the polymer may have a melting point ranging from about 155° C. to about 225° C., from about 155° C. to about 215° C., about 160° C. to about 200° C., from about 170° C. to about 190° C., or from about 182° C. to about 189° C. As still another example, the polymer may be a polyamide having a melting point of about 180° C.

When the polymeric material is a thermoplastic elastomer, the thermoplastic elastomer may have a melting range within the range of from about 130° C. to about 250° C. In some examples (e.g., when the thermoplastic elastomer is a polyether block amide), the thermoplastic elastomer may have a melting range of from about 130° C. to about 175° C. In some other examples (e.g., when the thermoplastic elastomer is a thermoplastic polyurethane), the thermoplastic elastomer may have a melting range of from about 130° C. to about 180° C. or a melting range of from about 175° C. to about 210° C.

In some examples, the polymeric material does not substantially absorb radiation having a wavelength within the range of 300 nm to 1400 nm. The phrase “does not substantially absorb” means that the absorptivity of the thermoplastic elastomer at a particular wavelength is 25% or less (e.g., 20%, 10%, 5%, etc.)

In some examples, in addition to the polymeric material, the build material composition may include an antioxidant, a whitener, an antistatic agent, a flow aid, or a combination thereof. While several examples of these additives are provided, it is to be understood that these additives are selected to be thermally stable (i.e., will not decompose) at the 3D printing temperatures.

Antioxidant(s) may be added to the build material composition to prevent or slow molecular weight decreases of the polymeric material and/or may prevent or slow discoloration (e.g., yellowing) of the polymeric material by preventing or slowing oxidation of the polymeric material. In some examples, the polymeric material may discolor upon reacting with oxygen, and this discoloration may contribute to the discoloration of the build material composition. The antioxidant may be selected to minimize discoloration. In some examples, the antioxidant may be a radical scavenger. In these examples, the antioxidant may include IRGANOX®1098 (benzenepropanamide, N,N′-1,6-hexanediylbis(3,5-bis(1,1-dimethylethyl)-4-hydroxy)), IRGANOX®254 (a mixture of 40% triethylene glycol bis(3-tert-butyl-4-hydroxy-5-methylphenyl), polyvinyl alcohol and deionized water), and/or other sterically hindered phenols. In other examples, the antioxidant may include a phosphite and/or an organic sulfide (e.g., a thioester). The antioxidant may be in the form of fine particles (e.g., having an average particle size of 5 μm or less) that are dry blended with the polymeric material. In an example, the antioxidant may be included in the build material composition in an amount ranging from about 0.01 wt % to about 5 wt %, based on the total weight of the build material composition. In other examples, the antioxidant may be included in the build material composition in an amount ranging from about 0.01 wt % to about 2 wt % or from about 0.2 wt % to about 1 wt %, based on the total weight of the build material composition.

Whitener(s) may be added to the build material composition to improve visibility. Examples of suitable whiteners include titanium dioxide (TiO₂), zinc oxide (ZnO), calcium carbonate (CaCO₃), zirconium dioxide (ZrO₂), aluminum oxide (Al₂O₃), silicon dioxide (SiO₂), boron nitride (BN), and combinations thereof. In some examples, a stilbene derivative may be used as the whitener and a brightener. In these examples, the temperature(s) of the 3D printing process may be selected so that the stilbene derivative remains stable (i.e., the 3D printing temperature does not thermally decompose the stilbene derivative). In an example, any example of the whitener may be included in the build material composition in an amount ranging from greater than 0 wt % to about 10 wt %, based on the total weight of the build material composition.

Antistatic agent(s) may be added to the build material composition to suppress tribo-charging. Examples of suitable antistatic agents include aliphatic amines (which may be ethoxylated), aliphatic amides, quaternary ammonium salts (e.g., behentrimonium chloride or cocamidopropyl betaine), esters of phosphoric acid, polyethylene glycolesters, or polyols. Some suitable commercially available antistatic agents include HOSTASTAT® FA 38 (natural based ethoxylated alkylamine), HOSTASTAT® FE2 (fatty acid ester), and HOSTASTAT® HS 1 (alkane sulfonate), each of which is available from Clariant Int. Ltd.). In an example, the antistatic agent is added in an amount ranging from greater than 0 wt % to less than 5 wt %, based upon the total weight of the build material composition.

Flow aid(s) may be added to improve the coating flowability of the build material composition. Flow aids may be particularly beneficial when the build material composition has an average particle size less than 25 μm. The flow aid improves the flowability of the build material composition by reducing the friction, the lateral drag, and the tribocharge buildup (by increasing the particle conductivity). Examples of suitable flow aids include aluminum oxide (Al₂O₃), tricalcium phosphate (E341), powdered cellulose (E460(ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), silicon dioxide (E551), calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), and polydimethylsiloxane (E900). In an example, the flow aid is added in an amount ranging from greater than 0 wt % to less than 5 wt %, based upon the total weight of the build material composition.

### Detailing Agent

A detailing agent may be used in combination with the multi-functional agent in examples of the 3D printing method. The detailing agent does not include an energy absorber, and may be applied to portion(s) of the build material composition that are outside of the 3D object model. The portion(s) of the build material composition exposed to the detailing agent may experience a cooling effect, and thus the detailing agent helps to keep the portion(s) from coalescing.

The detailing agent may include a surfactant, a co-solvent, and a balance of water. In some examples, the detailing agent consists of these components, and no other components. In some other examples, the detailing agent may further include a colorant. In still some other examples, the detailing agent consists of a colorant, a surfactant, a co-solvent, and a balance of water, with no other components. In yet some other examples, the detailing agent may further include additional components, such as anti-kogation agent(s), anti-microbial agent(s), and/or chelating agent(s) (each of which is described above in reference to the non-conductive agent).

The surfactant(s) that may be used in the detailing agent include any of the surfactants listed herein in reference to the multi-functional agent and/or the non-conductive agent. The total amount of surfactant(s) in the detailing agent may range from about 0.10 wt % active to about 5.00 wt % active with respect to the total weight of the detailing agent.

The co-solvent(s) that may be used in the detailing agent include any of the co-solvents listed above in reference to the multi-functional agent and/or the non-conductive agent. The total amount of co-solvent(s) in the detailing agent may range from about 1 wt % active to about 65 wt % active with respect to the total weight of the detailing agent.

In some examples, the detailing agent does not include a colorant. In these examples, the detailing agent may be colorless. As used herein, “colorless,” means that the detailing agent is achromatic and does not include a colorant. The colorless detailing agent may be used with any of the other agents disclosed herein.

In other examples, the detailing agent does include a colorant. It may be desirable to add color to the detailing agent when the detailing agent is applied to the edge of a colored 3D object, such as an object formed using the non-conductive agent. Color in the detailing agent may be desirable when used at a part edge because some of the colorant may become embedded in the build material composition that fuses/coalesces at the edge. As such, in some examples, the dye in the detailing agent may be selected so that its color matches the color of the energy absorber in the multi-functional agent or the non-conductive agent. As examples, the dye may be any azo dye having sodium or potassium counter ion(s) or any diazo (i.e., double azo) dye having sodium or potassium counter ion(s), where the color of azo or dye azo dye matches the color of the multi-functional agent or the non-conductive agent.

When the detailing agent includes the colorant, the colorant may be a dye of any color having substantially no absorbance in a range of 650 nm to 2500 nm. By “substantially no absorbance” it is meant that the dye absorbs no radiation having wavelengths in a range of 650 nm to 2500 nm, or that the dye absorbs less than 10% of radiation having wavelengths in a range of 650 nm to 2500 nm. The dye may also be capable of absorbing radiation with wavelengths of 650 nm or less. As such, the dye absorbs at least some wavelengths within the visible spectrum, but absorbs little or no wavelengths within the near-infrared spectrum. This is in contrast to the energy absorbers in each of the multi-functional agent and the non-conductive agent, which absorb wavelengths within the near-infrared spectrum. As such, the colorant in the detailing agent will not substantially absorb the fusing radiation, and thus will not initiate melting and fusing (coalescence) of the build material composition in contact therewith when the build material layer is exposed to the energy.

In an example, the dye is a black dye. Some examples of the black dye include azo dyes having sodium or potassium counter ion(s) and diazo (i.e., double azo) dyes having sodium or potassium counter ion(s). Examples of azo and diazo dyes may include tetrasodium (6Z)-4-acetamido-5-oxo-6-[[7-sulfonato-4-(4-sulfonatophenyl)azo-1-naphthyl]hydrazono]naphthalene-1,7-disulfonate with a chemical structure of:

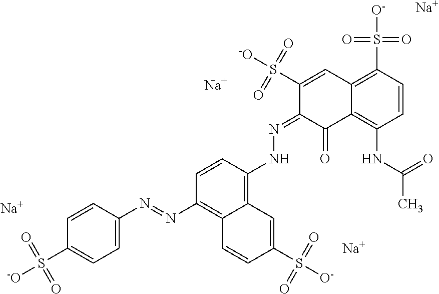

(commercially available as Food Black 1); tetrasodium 6-amino-4-hydroxy-3-[[7-sulfonato-4-[(4-sulfonatophenyl)azo]-1-naphthyl]azo]naphthalene-2,7-disulfonate with a chemical structure of:

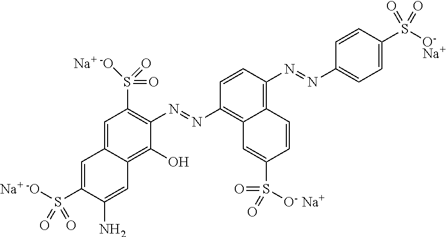

(commercially available as Food Black 2); tetrasodium (6E)-4-amino-5-oxo-3-[[4-(2-sulfonatooxyethylsulfonyl)phenyl]diazenyl]-6-[[4-(2-sulfonatooxyethylsulfonyl)phenyl]hydrazinylidene]naphthalene-2,7-disulfonate with a chemical structure of:

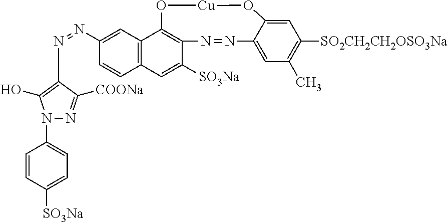

(commercially available as Reactive Black 31); tetrasodium (6E)-4-amino-5-oxo-3-[[4-(2-sulfonatooxyethylsulfonyl)phenyl]diazenyl]-6-[[4-(2-sulfonatooxyethylsulfonyl)phenyl]hydrazinylidene]naphthalene-2,7-disulfonate with a chemical structure of:

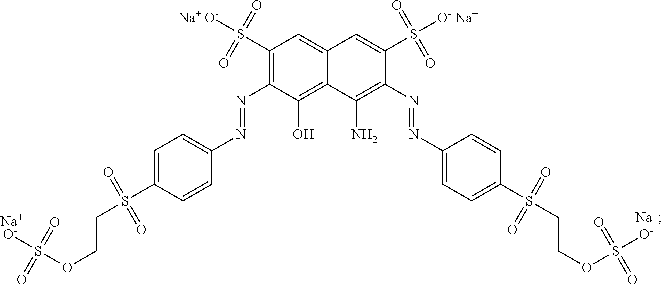

and combinations thereof. Some other commercially available examples of the dye used in the detailing agent include multipurpose black azo-dye based liquids, such as PRO-JET® Fast Black 1 (made available by Fujifilm Holdings), and black azo-dye based liquids with enhanced water fastness, such as PRO-JET® Fast Black 2 (made available by Fujifilm Holdings).

In some instances, in addition to the black dye, the colorant in the detailing agent may further include another dye. In an example, the other dye may be a cyan dye that is used in combination with any of the dyes disclosed herein. The other dye may also have substantially no absorbance above 650 nm. The other dye may be any colored dye that contributes to improving the hue and color uniformity of the final 3D printed polyamide object.

Some examples of the other dye include a salt, such as a sodium salt, an ammonium salt, or a potassium salt. Some specific examples include ethyl-[4-[[4-[ethyl-[(3-sulfophenyl) methyl]amino]phenyl]-(2-sulfophenyl) ethylidene]-1-cyclohexa-2,5-dienylidene]-[(3-sulfophenyl) methyl]azanium with a chemical structure of:

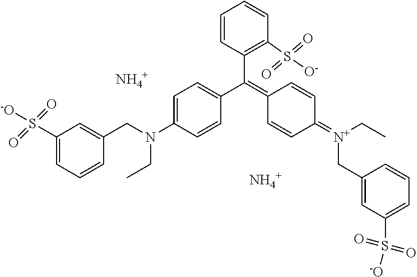

(commercially available as Acid Blue 9, where the counter ion may alternatively be sodium counter ions or potassium counter ions), sodium 4-[(E)-{4-[benzyl(ethyl)amino]phenyl}{(4E)-4-[benzyl(ethyl)iminio]cyclohexa-2,5-dien-1-ylidene}methyl]benzene-1,3-disulfonate with a chemical structure of:

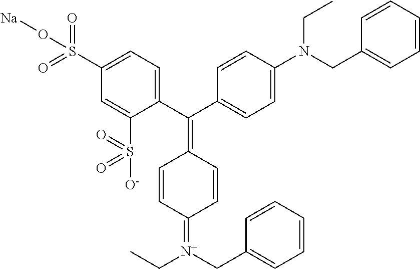

(commercially available as Acid Blue 7); and a phthalocyanine with a chemical structure of:

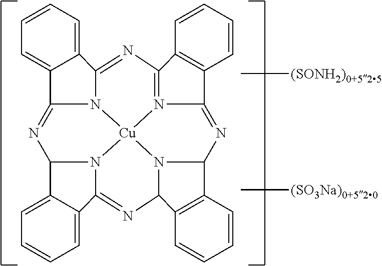

(commercially available as Direct Blue 199); and combinations thereof.

In an example of the detailing agent, the dye may be present in an amount ranging from about 1 wt % active to about 3 wt % active based on the total weight of the detailing agent. In another example of the detailing agent including a combination of dyes, one dye (e.g., the black dye) is present in an amount ranging from about 1.50 wt % active to about 1.75 wt % active based on the total weight of the detailing agent, and the other dye (e.g., the cyan dye) is present in an amount ranging from about 0.25 wt % active to about 0.50 wt % active based on the total weight of the detailing agent.

The balance of the detailing agent is water. As such, the amount of water may vary depending upon the amounts of the other components that are included.

### Sets and Kits

The multi-functional agent may be part of a multi-fluid kit with any example of the non-conductive agent and/or the detailing agent. The multi-functional agent may also be part of a 3D printing kit with the build material composition, alone or in combination with one or more of the other agent(s).

It is to be understood that the fluid(s) of the multi-fluid kit and the fluid(s) and the build material composition of the 3D printing kits may be maintained separately until used together in examples of the 3D printing method disclosed herein. The fluid(s) and composition may each be contained in one or more containers prior to and during printing, but may be combined together during printing. The containers can be any type of a vessel (e.g., a reservoir), box, or receptacle made of any material.

### Printing Methods

The multi-functional agent disclosed herein may be used in the 3D printing method disclosed herein. The 3D printing method generally includes spreading a polymeric build material composition to form a build material layer; based on data derived from a digital 3D object model, selectively applying a multi-functional agent to at least a portion of the build material layer, the multi-functional agent including: carboxylated carbon nanotubes present in an amount ranging from about 0.5 wt % active to about 5.5 wt % active based on a total weight of the multi-functional agent; poly(3,4-ethylenedioxythiophene) polystyrene sulfonate (PEDOT:PSS) present in an amount ranging from about 0.1 wt % active to about 0.8 wt % active based on the total weight of the multi-functional agent; a co-solvent; and a balance of water; and exposing the build material layer to infrared radiation to coalesce the build material composition in the at least the portion, thereby forming a layer of a 3D object. To form the 3D object, the method may be repeated. As such, the method may further include iteratively applying individual build material layers of the polymeric build material composition, iteratively selectively applying the multi-functional agent to pattern each of the build material layers, and iteratively exposing the build material layers to infrared radiation.

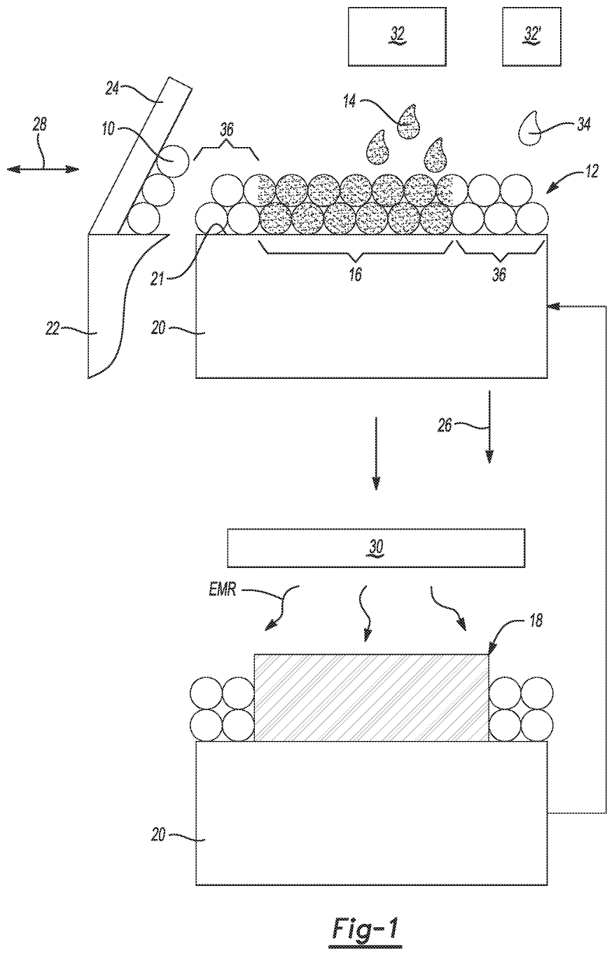

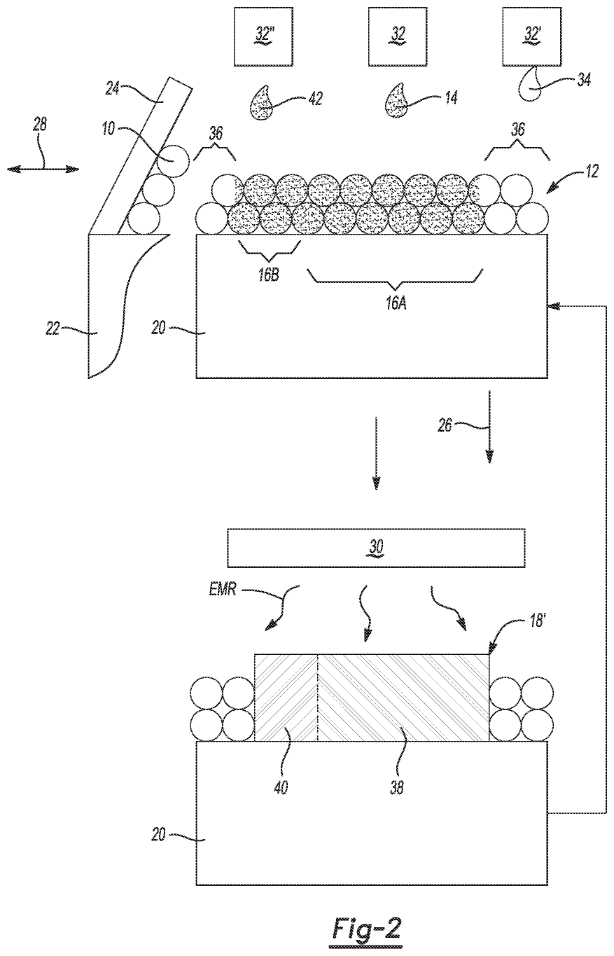

Different examples of the 3D printing method that utilize the multi-functional agent are shown and described in reference to FIG. 1 and FIG. 2.

Prior to execution of any examples of the method, it is to be understood that a controller may access data stored in a data store pertaining to a 3D part/object that is to be printed. The data may include a digital model of the 3D part/object that is to be built, and additional data, for example, the number of layers of the build material composition that are to be formed, the locations at which any of the agents is/are to be deposited on each of the respective layers, etc. may be derived from this digital 3D object model.

Printing with the Multi-Functional Agent

Referring now to FIG. 1, an example of a 3D printing method which the multi-functional agent is schematically depicted.

The method shown in FIG. 1 includes spreading the build material composition 10 to form a build material layer 12; based on a 3D object model, selectively applying the multi-functional agent 14 onto the build material layer 12, thereby forming a patterned portion 16; and exposing the build material layer 12 to electromagnetic radiation EMR to selectively coalesce the patterned portion 16 and form a 3D printed object layer 18.

Prior to spreading, the method may further include applying the build material composition 10 to a build area platform 20 having an X-Y plane (at surface 21). In FIG. 1, the layer 12 of the build material composition 10 is formed on the build area platform 20. A printing system may be used to apply the build material composition 10. The printing system may include the build area platform 20, a build material supply 22 containing the build material composition 10, and a build material distributor 24.

The surface 21 of the build area platform 20 provides the X-Y plane for building the 3D printed object. The surface 21 receives the build material composition 10 from the build material supply 22. The build area platform 20 may be moved in the directions as denoted by the arrow 26, e.g., along the Z-axis, so that the build material composition 10 may be delivered to the build area platform 20 or to a previously formed layer. In an example, when the build material composition 10 is to be delivered, the build area platform 20 may be programmed to advance (e.g., downward) enough so that the build material distributor 24 can push the build material composition 10 onto the build area platform 20 to form a substantially uniform layer 12 of the build material composition 10 thereon. The build area platform 20 may also be returned to its original position, for example, when a new part is to be built.

The build material supply 22 may be a container, bed, or other surface that is to position the build material composition 10 between the build material distributor 24 and the build area platform 20. The build material supply 22 may include heaters so that the build material composition 10 is heated to a supply temperature ranging from about 25° C. to about 150° C. In these examples, the supply temperature may depend, in part, on the build material composition 10 used and/or the 3D printer used. As such, the range provided is one example, and higher or lower temperatures may be used.

The build material distributor 24 may be moved in the directions as denoted by the arrow 28, e.g., along the Y-axis, over the build material supply 22 and across the build area platform 20 to spread the layer 12 of the build material composition 10 over the build area platform 20. In this example, the spreading is performed in the Y-direction of the X-Y plane. The build material distributor 24 may also be returned to a position adjacent to the build material supply 22 following the spreading of the build material composition 10. The build material distributor 24 may be a blade (e.g., a doctor blade), a roller, a combination of a roller and a blade, and/or any other device capable of spreading the build material composition 10 over the build area platform 20. For instance, the build material distributor 24 may be a counter-rotating roller. In some examples, the build material supply 22 or a portion of the build material supply 22 may translate along with the build material distributor 24 such that build material composition 10 is delivered continuously to the build area platform 20 rather than being supplied from a single location at the side of the printing system as depicted in FIG. 1.

The build material supply 22 may supply the build material composition 10 into a position so that it is ready to be spread onto the build area platform 20. The build material distributor 24 may spread the supplied build material composition 10 onto the build area platform 20. The controller (not shown) may process “control build material supply” data, and in response, control the build material supply 22 to appropriately position the particles of the build material composition 10, and may process “control spreader” data, and in response, control the build material distributor 24 to spread the build material composition 10 over the build area platform 20 to form the layer 12. In FIG. 1, one build material layer 12 has been formed.

The layer 12 has a substantially uniform thickness across the build area platform 20. In an example, the build material layer 12 has a thickness ranging from about 50 μm to about 120 μm. In another example, the thickness of the build material layer 12 ranges from about 30 μm to about 300 μm. It is to be understood that thinner or thicker layers may also be used. For example, the thickness of the build material layer 12 may range from about 20 μm to about 500 μm. The layer thickness may be about 2× (i.e., 2 times) the average particle size (e.g., diameter) of the polyamide particles at a minimum for finer part definition. In some examples, the layer thickness may be about 1.2× the average diameter of the polyamide particles in the build material composition 10.

After the build material composition 10 has been applied and spread, and prior to further processing, the build material layer 12 may be exposed to heating. In an example, the heating temperature may be below the melting point or the lowest temperature of the melting range of the polymeric material in the build material composition 10. As examples, the pre-heating temperature may range from about 10° C. to about 150° C. below the melting point or the lowest temperature of the melting range of the polymeric material. In an example, the pre-heating temperature ranges from about 50° C. to about 170° C.

Pre-heating the layer 12 may be accomplished by using any suitable heat source that exposes all of the build material composition 10 in the layer 12 to the heat. Examples of the heat source include a thermal heat source (e.g., a heater (not shown) integrated into the build area platform 20 (which may include sidewalls)) or a radiation source 30.

After the layer 12 is formed, and in some instances is pre-heated, the multi-functional agent 14 is selectively applied on at least some of the build material composition 10 in the layer 12 to form a patterned portion 16.

To form a layer 18 of a 3D printed object, at least a portion (e.g., patterned portion 16) of the layer 12 of the build material composition 10 is patterned with the multi-functional agent 14.

The volume of the multi-functional agent 14 that is applied per unit of the build material composition 10 in the patterned portion 16 may be sufficient to absorb and convert enough electromagnetic radiation so that the build material composition 10 in the patterned portion 16 will coalesce/fuse. The volume that is applied depends upon the concentration of the carboxylated carbon nanotubes and the PEDOT:PSS in the multi-functional agent 14 and the desired weight percentage of the conductive fillers in the final 3D object. The volume dispensed can be controlled by the number of dispensing times and the number of printheads used during each dispensing time.

The multi-functional agent 14 may be dispensed from an applicator 32. The applicator 32 may include a thermal inkjet printhead, a piezoelectric printhead, a continuous inkjet printhead, etc., and the selective application of the multi-functional agent 14 may be accomplished by thermal inkjet printing, piezo electric inkjet printing, continuous inkjet printing, etc. The controller may process data, and in response, control the applicator 32 to deposit the multi-functional agent 14 onto the predetermined portion(s) 16 of the build material composition 10.

It is to be understood that the selective application of the multi-functional agent 14 may follow a predetermined dispensing time, which equates to the number of times that the multi-functional layer 14 is applied to a build material layer 12. During one or more printing passes, the number of active printheads in each applicator 32 is controlled in order to achieve the dispensing time. In an example, each applicator 32 includes two printheads, and the two printheads are independently and selectively activated during each pass over the build material composition 10 to apply the multi-functional agent 14 in accordance with the dispensing time (e.g., 1 time, 2 times, etc.). When the dispensing time is over 1, it may be desirable to apply the multi-functional agent 14 in multiple printing passes in order to increase the amount, e.g., of the energy absorbers that are applied to the build material composition 10, to avoid liquid splashing, to avoid displacement of the build material composition 10, etc.

In one example of the method, the selective application of the multi-functional agent 14 involves selectively applying the multi-functional agent 14 according to a dispensing time, wherein the dispensing time is achieved by: activating at least one of a plurality of printheads to dispense the multi-functional agent 14 in a first pass of the plurality of printheads over the build material layer 10; and one of: i) inactivating all of the plurality of printheads in a second pass of the plurality of printheads over the build material layer 10; or ii) activating at least one of a plurality of printheads to dispense the multi-functional agent 14 in the second pass of the plurality of printheads over the build material layer.

In one specific example, the number of printing passes is 2, the number of dispensing times (t) ranges from 1 to 8, the number of applicators 32 is 2, and the number of printheads in each of the two applicators 32 is 2. In this example then, the total number of printheads is 4. One example of the selective application with this configuration involves one of the following: i) in a first dispensing time (t=1), one of the plurality of printheads is activated in the first pass of the plurality of printheads over the build material layer 10 and all of the plurality of printheads are inactivated in the second pass of the plurality of printheads over the build material layer 10; or ii) in a second dispensing time (t=2), two of the plurality of printheads are activated in the first pass of the plurality of printheads over the build material layer 10 and all of the plurality of printheads are inactivated in the second pass of the plurality of printheads over the build material layer 10; or iii) in a third dispensing time (t=3), three of the plurality of printheads are activated in the first pass of the plurality of printheads over the build material layer 10 and all of the plurality of printheads are inactivated in the second pass of the plurality of printheads over the build material layer 10; or iv) in a fourth dispensing time (t=4), four of the plurality of printheads are activated in the first pass of the plurality of printheads over the build material layer 10 and all of the plurality of printheads are inactivated in the second pass of the plurality of printheads over the build material layer 10; or v) in a fifth dispensing time (t=5), four of the plurality of printheads are activated in the first pass of the plurality of printheads over the build material layer 10 and one of the plurality of printheads is activated in the second pass of the plurality of printheads over the build material layer 10; or vi) in a sixth dispensing time (t=6), four of the plurality of printheads are activated in the first pass of the plurality of printheads over the build material layer 10 and two of the plurality of printheads are activated in the second pass of the plurality of printheads over the build material layer 10; or vii) in a seventh dispensing time (t=7), four of the plurality of printheads are activated in the first pass of the plurality of printheads over the build material layer 10 and three of the plurality of printheads are activated in the second pass of the plurality of printheads over the build material layer 10; or viii) in an eighth dispensing time (t=8), four of the plurality of printheads are activated in the first pass of the plurality of printheads over the build material layer 10 and four of the plurality of printheads are activated in the second pass of the plurality of printheads over the build material layer 10.

In the example shown in FIG. 1, the detailing agent 34 is also selectively applied to the portion(s) 36 of the layer 12. The portion(s) 36 are not patterned with the multi-functional agent 14 and thus are not to become part of the final 3D printed object layer 18. Thermal energy generated during radiation exposure may propagate into the surrounding portion(s) 36 that do not have the multi-functional agent 14 applied thereto. The propagation of thermal energy may be inhibited, and thus the coalescence of the non-patterned build material portion(s) 36 may be prevented, when the detailing agent 34 is applied to these portion(s) 36.

The detailing agent 34 may also be dispensed from an applicator 32′. The applicator 32′ may include any of the inkjet printheads set forth herein. It is to be understood that the applicators 32, 32′ may be separate applicators or may be a single applicator with several individual cartridges for dispensing the respective agents 14 or and 34. The detailing agent 34 may also be selectively applied in a single printing pass or in multiple printing passes, over a single or multiple dispensing times, and using any number of activated printheads.

After the agents 14 and 34 are selectively applied in the specific portion(s) 16 and 36 of the layer 12, the entire layer 12 of the build material composition 10 is exposed to electromagnetic radiation (shown as EMR in FIG. 1). In the examples set forth herein, the electromagnetic radiation is infrared radiation or near infrared radiation.

The electromagnetic radiation is emitted from the radiation source 30. An example of the radiation source 30 includes an IR lamp. As example, the electromagnetic radiation emitted from the radiation source 30 has a wavelength ranging from 700 nm to 1 mm, or from 780 nm to 2,500 nm.

The length of time for electromagnetic radiation exposure, or energy exposure time, may be dependent, for example, on one or more of: characteristics of the 3D printer; characteristics of the radiation source 30; characteristics of the build material composition 10; and/or characteristics of the multi-functional agent 14. In one example, the scanning speed of the radiation source 30 is 16 inches per second, and each pass may range from about 2 seconds to about 6 seconds. The total exposure time may also depend upon the number of passes.

It is to be understood that the electromagnetic radiation exposure may be accomplished in a single radiation event or in multiple radiation events. In an example, the exposure of the build material composition 10 to electromagnetic radiation is accomplished in multiple radiation events, each of which corresponds with a printing pass. Thus, in some instances, a printing pass may be performed concurrent with, or may be followed by, a radiation event. It is to be understood that a radiation event may take place during a printing pass where no fluid 14, 34 is applied (i.e., where the printheads are not activated). For example, a dispensing time may involve two passes: the first of which involves fluid 14, 34 application and a radiation event, and the second of which involves a radiation event alone (without any fluid dispensing).

In an example method involving multiple dispensing times, the number of radiation events may vary depending on the total number of dispensing times and the number of printing passes per dispensing time. In the example involving 8 dispensing times (each including 2 printing passes), the total number of radiation events is 16 because one radiation event follows one printing pass. In other examples, the total number of radiation events ranges from 2 to 20. It may be desirable to expose the build material composition 10 to electromagnetic radiation in multiple radiation events to counteract a cooling effect that may be brought on by the amount of the agents 14 and 34 that is applied to the build material layer 12. Additionally, it may be desirable to expose the build material composition 10 to electromagnetic radiation in multiple radiation events to sufficiently elevate the temperature of the build material composition 10 in the portion(s) 16, 36, without over heating the build material composition 10 in the non-patterned portion(s) 36.

The multi-functional agent 14 enhances the absorption of the radiation, converts the absorbed radiation to thermal energy, and promotes the transfer of the thermal heat to the build material composition 10 in contact therewith. In an example, the multi-functional agent 14 sufficiently elevates the temperature of the build material composition 10 in the portion 16 to a temperature above the melting point or the lowest temperature in the melting range of the polymeric material, allowing coalescing/fusing (e.g., thermal merging, melting, binding, etc.) of the build material composition 10 to take place. The application of the electromagnetic radiation forms the 3D printed object layer 18.

The non-patterned build material composition 10 in portion(s) 36 is not patterned with the multi-functional agent 14 and thus is not exposed to the carboxylated nanotube and PEDOT:PSS energy absorbers. As such, while the non-patterned build material composition 10 in portion(s) 36 may be heated because it is present on the build area platform 20, it does not absorb the radiation and thus does not reach the melting temperature(s) of the polymeric material in the build material composition 10. As such, the portion(s) 36 are do not become part of the 3D printed object layer. In fact, the non-patterned build material composition 10 may be collected and reused in subsequent 3D printing cycles.

After the 3D printed object layer 18 is formed, additional layer(s) may be formed thereon to create an example of the 3D printed object. To form the next layer, additional build material composition 10 may be applied on the layer 18. The multi-functional agent 14 is then selectively applied on at least a portion of the additional build material composition 10, according to data derived from the 3D object model. The detailing agent 34 may be applied in any area of the additional build material composition 10 where coalescence is not desirable. After the agent(s) 14 and 34 is/are applied, the entire layer of the additional build material composition 10 is exposed to electromagnetic radiation (e.g., infrared radiation) in the manner described herein. The application of additional build material composition 10, the selective application of the agent(s) 14, 34, and the electromagnetic radiation exposure may be repeated a predetermined number of cycles to form the final 3D printed object in accordance with the 3D object model.

In the example shown in FIG. 1, it is to be understood that the entire 3D object layer 18 is conducting, as the multi-functional agent 14 is used to pattern the entire portion 16 that becomes the layer 18. If the multi-functional agent 14 alone is used to pattern all of the layers in accordance with the 3D object model, the entire 3D object that is formed will be conductive.

Printing with the Multi-Functional and the Non-Conductive Agents

Referring now to FIG. 2, an example of the 3D printing method is depicted that utilizes both the multi-functional agent 14 and the non-conductive agent 42.

The method shown in FIG. 2 includes applying a build material composition 10 to form a build material layer 12; based on data derived from a digital 3D object model, selectively applying a multi-functional agent 14 onto the build material layer 12, thereby forming a first patterned portion 16A; based on the data derived from the 3D object model, selectively applying a non-conductive agent 42 onto another portion of the build material layer 12, thereby forming a second patterned portion 16B; and exposing the build material layer 12 to electromagnetic radiation EMR to selectively coalesce the patterned portions 16A and 16B and form a 3D printed object layer 18′.

In FIG. 2, one layer 12 of the build material composition 10 is applied on the build area platform 20 as described in reference to FIG. 1. After the build material composition 10 has been applied, and prior to further processing, the build material layer 12 may be exposed to pre-heating as described in reference to FIG. 1.

In this example of the 3D printing method, the multi-functional agent 14 is selectively applied on at least some of the build material composition 10 in the layer 12 to form a first patterned portion 16A; and the non-conductive agent 42 is selectively applied on at least some other of the build material composition 10 in the layer 12 to form second patterned portion(s) 16B. The multi-functional agent 14 is applied wherever it is desirable to i) coalesce the build material composition 10 and ii) form an electrically conductive portion of the 3D object. The non-conductive agent 42 is applied wherever it is desirable to i) coalesce the build material composition 10 and ii) form an electrically insulating portion of the 3D object. The portions 16A, 16B may or may not be adjacent to one another depending upon the 3D object model and the location of the conductive and insulating portions within the 3D object model.

The volume of the multi-functional agent 14 that is applied per unit of the build material composition 10 in the first patterned portion 16A may be sufficient to absorb and convert enough electromagnetic radiation so that the build material composition 10 in the patterned portion 16A will coalesce/fuse. Similarly, the volume of the non-conductive agent 42 that is applied per unit of the build material composition 10 in the second patterned portion 16B may be sufficient to absorb and convert enough electromagnetic radiation so that the build material composition 10 in the second patterned portion 16B will coalesce/fuse.

The agents 14, 42 may be applied via separate applicators 32, 32″ or via separate printheads within a single applicator 32.

In the example shown in FIG. 2, the detailing agent 34 is also selectively applied to the portion(s) 36 of the layer 12. The portion(s) 36 are not patterned with the multi-functional agent 14 or the non-conductive agent 42, and thus are not to become part of the final 3D printed object layer 18′.

After the agents 14, 42, and 34 are selectively applied in the specific portion(s) 16A, 16B, and 36 of the layer 12, the entire layer 12 of the build material composition 10 is exposed to electromagnetic radiation (shown as EMR in FIG. 2). Radiation exposure may be accomplished as described in reference to FIG. 1.

In this example, both the multi-functional agent 14 and the non-conductive agent 42 enhance the absorption of the radiation, convert the absorbed radiation to thermal energy, and promote the transfer of the thermal heat to the build material composition 10 in contact therewith. In an example, the multi-functional agent 14 and the non-conductive agent 42 (due to the respective energy absorbers therein) sufficiently elevate the temperature of the build material composition 10 in the respective portions 16A, 16B to a temperature above the melting point or the lowest temperature of the melting range of the polymeric material, allowing coalescing/fusing (e.g., thermal merging, melting, binding, etc.) of the build material composition 10 to take place. The application of the electromagnetic radiation forms the 3D printed object layer 18′, which, in this example, includes a conductive portion 38 (corresponding with patterned portion 16A) and an insulating portion 40 (corresponding with patterned portion 16B at opposed ends of the 3D object layer 18′.

FIG. 2 illustrates one example of how the multi-functional agent 14 and the non-conductive agent 42 may be used together to pattern a single build material layer 12 and form one layer 18′ of the 3D printed object. The agents 14, 42 may be used to pattern separate build material layers as well.

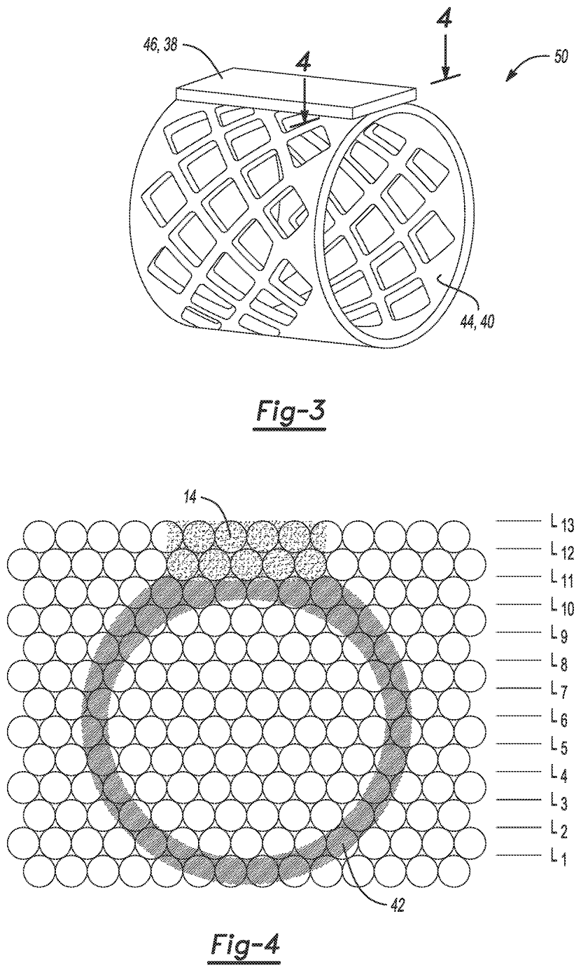

An example of a 3D object 50 (i.e., 3D printed article) that can be generated with the agents 14, 42 set forth herein is depicted in FIG. 3. This example 3D object 50 is a wearable device that includes a band 44 and a sensor 46. The band 44 is formed of coalesced build material that had been patterned with the non-conductive agent 42, and thus the band 44 is electrically insulating (i.e., electrically insulating portion 40). The sensor 46 is formed of coalesced build material that had been patterned with the multi-functional agent 14, and thus the sensor 46 is electrically conductive (i.e., electrically conducting portion 38).

The patterned build material layers L₁-L₁₃ that correspond with the cross-section of the 3D object 50 taken along line 4-4 of FIG. 3 are depicted in FIG. 4. This figure illustrates an example of how the individual layers L₁-L₁₃ could be patterned, and does not illustrate the radiation exposure of each layer L₁-L₁₃. As illustrated in FIG. 4, several of the layers L₁-L₁₁ are patterned with the non-conductive agent 42 alone (to form the non-conductive band 44, 40) and several of the layers L₁₂-L₁₃ are patterned with the multi-functional agent 14 alone (to form the conductive sensor 46, 38).

The cross-section represented in FIG. 4 depicts the patterned build material as if the 3D object 50 was printed from the bottom of the object 50 to the top of the object 50 in the Z-direction. However, it is to be understood that the 3D printed object 50 may be printed in any orientation with respect to the X-Y plane of the build area platform 20, and thus with respect to the layers 12 of the build material composition 10. For example, the 3D printed object could alternatively be printed at an inverted orientation (e.g., from top to bottom) in the Z-direction. For another example, the 3D printed object 50 can be printed at an angle or on its side. In this example, some of the layers L₁-L₁₃ would be patterned with both of the agents 14, 42. The orientation of the build within the build material composition 10 can be selected in advance or even by the user at the time of printing, for example.

While an example of a 3D printed object 50 generated with the combination of the multi-functional and non-conductive agents 14, 42 has been described, it is to be understood that the multi-functional and non-conductive agents 14, 42 may be used to form any desirable 3D printed object having electrically conductive and electrically insulating portions 38, 40.

An example of the 3D object 50 (i.e., 3D printed article) disclosed herein includes coalesced polymeric build material, wherein at least a portion (e.g., portion 46, 38) of the coalesced polymeric build material is electrically conductive and includes intermingled therein carboxylated carbon nanotubes in an amount ranging from about 0.01 wt % to about 10 wt % based on a total weight of the 3D printed article and poly(3,4-ethylenedioxythiophene) polystyrene sulfonate (PEDOT:PSS) in an amount ranging from about 0.01 wt % to about 1 wt % based on the total weight of the 3D printed article. In one specific example 3D object 50 (i.e., 3D printed article), at least a portion (e.g., portion 46, 38) of the coalesced polymeric build material is electrically conductive and includes intermingled therein carboxylated carbon nanotubes in an of about 0.5 wt % based on a total weight of the 3D printed article and poly(3,4-ethylenedioxythiophene) polystyrene sulfonate (PEDOT:PSS) in an amount of about 0.06 wt % based on the total weight of the 3D printed article. In some examples of the 3D printed article (e.g., as described in reference to FIG. 2 through FIG. 4), another portion (e.g., 44, 40) of the coalesced polymeric build material is electrically insulating.

The 3D printing method disclosed herein enables the ability to print complex structures, and the flexibility of the 3D object can be readily tailored by changing the design of to fit various parts of a human body. In addition, conductivity with a smooth gradient can be achieved in a single part by voxel tailoring through controlling the multi-functional agent 14 dispensing times and the number of nozzles used in the printheads for each dispensing.

To further illustrate the present disclosure, examples are given herein. It is to be understood that these examples are provided for illustrative purposes and are not to be construed as limiting the scope of the present disclosure.

### EXAMPLES

### Example 1

Several example multi-functional agents in accordance with the examples disclosed herein were prepared. Several comparative and control agents were also prepared. A commercially available multi-walled carboxylated carbon nanotube dispersion (13 wt %, surfactant included, available from XFNANO Materials Tech Co. Ltd., China) was used to prepare the example agents, the comparative agents, and one set of control agents. A commercially available PEDOT:PSS aqueous solution (1.1%, surfactant included, available from Sigma-Aldrich) was used to prepare the example agents, the comparative agents, and another set of control agents. The example formulations, the comparative example formulations, and the different control agents were exposed to four cycles of: mixing via sonication for 45 minutes (using a probe sonicator (Q500, Qsonica LLC)) followed by filtering via a 1-μm pore size filter. The filtration helped remove aggregates of the nanotubes and the PEDOT:PSS.

The example formulations are shown in Table 1A, the comparative example formulations are shown in Table 1 BC, the controls formed with carboxylated CNTs (but no PEDOT:PSS) are shown in Table 1C, and the controls formed with PEDOT:PSS (but no carboxylated CNTs) are shown in Table 1 D. All of the values in Tables 1A-1 D are weight percent active.

TABLE 1A
Example Multi-Functional Agents

| Ingredient | Ex. 1 | Ex. 2 | Ex. 3 | Ex. 4 | Ex. 5 | Ex. 6 |
|---|---|---|---|---|---|---|
| Carboxylated | 5.0 | 4.2 | 3.0 | 4.2 | 3.0 | 2.25 |
| CNT | | | | | | |
| PEDOT:PSS | 0.25 | 0.25 | 0.25 | 0.5 | 0.5 | 0.75 |
| Non-ionic | 0.1-1.0 | 0.1-1.0 | 0.1-1.0 | 0.1-1.0 | 0.1-1.0 | 0.1-1.0 |
| surfactant* | | | | | | |
| 2-pyrrolidinone | 13 | 13 | 13 | 13 | 13 | 13 |
| Deionized | Balance | Balance | Balance | Balance | Balance | Balance |
| water | | | | | | |

*introduced from the carboxylated CNT dispersion and the PEDOT:PSS solution

TABLE 1B
Comparative Example Agents

| | Comp. | Comp. |
|---|---|---|
| Ingredient | Ex. 7 | Ex. 8 |
| Carboxylated | 5.0 | 4.5 |
| CNT | | |
| PEDOT:PSS | 0.5 | 0.75 |
| Non-ionic | 0.1-1.0 | 0.1-1.0 |
| surfactant* | | |
| 2-pyrrolidinone | 13 | 13 |
| Deionized water | Balance | Balance |

*introduced from the carboxylated CNT dispersion and the PEDOT:PSS solution

TABLE 1C
CNT Control Agents

| | Control | Control | Control | Control |
|---|---|---|---|---|
| Ingredient | 9 | 10 | 11 | 12 |
| Carboxylated | 6.0 | 5.0 | 4.0 | 3.0 |
| CNT | | | | |
| PEDOT:PSS | 0 | 0 | 0 | 0 |
| Non-ionic | 0.1-1.0 | 0.1-1.0 | 0.1-1.0 | 0.1-1.0 |
| surfactant* | | | | |
| 2-pyrrolidinone | 13 | 13 | 13 | 13 |
| Deionized water | Balance | Balance | Balance | Balance |

*introduced from the carboxylated CNT dispersion

TABLE 1D
PEDOT:PSS Control Agents

| | Control | Control | Control |
|---|---|---|---|
| Ingredient | 13 | 14 | 15 |
| Carboxylated | 0 | 0 | 0 |
| CNT | | | |
| PEDOT:PSS | 0.5 | 0.75 | 1.0 |
| Non-ionic | 0.1-1.0 | 0.1-1.0 | 0.1-1.0 |
| surfactant* | | | |
| 2-pyrrolidinone | 13 | 13 | 13 |
| Deionized water | Balance | Balance | Balance |

*introduced from the PEDOT:PSS solution

The example, comparative, and control agents were tested for printability in terms of ink jettability and powder fusion. For this test, a testbed 3D printer was used. The testbed 3D printer included a moving carriage that holds an ink cartridge, which includes two thermal inkjet printheads having a plurality of nozzles (each having a size of 16 μm). The heating system of the testbed 3D printed was composed of an overhead lamp positioned above the build platform and an IR fusing lamp on either side of the ink cartridge.

The agents of Table 1A through 1D were loaded into respective ink cartridges, and put into position on the moving carriage when it was time to generate a 3D object with the particular agent.

The build material composition was a commercially available thermoplastic polyurethane, namely ULTRASINT® TPU01 from BASF Corp. A layer (thickness 80 μm) of the build material composition was applied on the printer's build platform. The carriage scanning speed was set at 16 inches/second, and the droplet dispensing resolution was 600 dots per inch (DPI) in the X direction. At this speed and resolution, the firing frequency of droplets was 9.6 kHz. The resolution of droplet dispensing in the Y direction was 1200 DPI. The desired agent was dispensed with a dispensing time of 1, where one of the printheads was activated in a first pass of the cartridge over the layer and was inactivated in a second pass of the cartridge over the layer (back and forth in the X direction). During dispensing, the powder and agent were also exposed to IR radiation from the lamps. This process was repeated with multiple layers to form a 3D object of 1 mm thickness. The 3D objects were 20 mm×10 mm (length×width). This process was performed for each of the agents.

During printing, printhead clogging and good printability were assessed. If the printhead clogged, the agent did not have good printability, and if the printhead did not clog, the agent had good printability. Also during printing, the temperature distribution of the powder bed was recorded by an infrared camera (A655sc, FLIR systems Inc.). If the temperature recorded by the infrared camera did not reach the median melting temperature of the thermoplastic polyurethane (about 140° C.), it was concluded that fusing was incomplete.

The results for printhead clogging (Yes or No), good printability (Yes or No), and fusing (Complete or Incomplete) are set forth in Table 2.

TABLE 2

| | Printhead | Good | |
|---|---|---|---|
| Agent ID | Clogging | Printability | Fusing |
| Ex. 1 | No | Yes | Complete |
| Ex. 2 | No | Yes | Complete |
| Ex. 3 | No | Yes | Complete |
| Ex. 4 | No | Yes | Complete |
| Ex. 5 | No | Yes | Complete |
| Ex. 6 | No | Yes | Complete |
| Comp. Ex. 7 | Yes | No | N/A |
| Comp. Ex. 8 | Yes | No | N/A |
| Control 9 | Yes | No | N/A |
| Control 10 | No | Yes | Complete |
| Control 11 | No | Yes | Complete |
| Control 12 | No | Yes | Complete |
| Control 13 | No | Yes | Incomplete |
| Control 14 | No | Yes | Incomplete |
| Control 15 | Yes | No | N/A |

Control 9 had the highest carboxylated CNT amount, with 6.0 wt % active. Comparative agents 7 and 8 had the highest combined energy absorber amount, with totals of 5.5 wt % active and 5.25 wt % active (combined CNT and PEDOT:PSS). Control agent 15 had the highest PEDOT:PSS, with 1.0 wt % active. Each of these control and comparative agents clogged the printhead. Control 13 and 14 were printable, but the resulting parts were underfused. Example agents 1-6 exhibited good printability and generated fused 3D objects. These results were similar to Control agents 10-12 (containing lower amounts of carboxylated CNTs and no PEDOT:PSS).

Ex. 4 was selected for further testing as it was printable and had one of the higher amounts of the combined energy absorbers (about 4.7 wt % total of CNTs and PEDOT:PSS), the latter of which should maximize heat absorption of the agent and lead to increased electrical conductivity.

Ex. 4 was compared with a non-conductive agent (a water-based agent including carbon black as the energy absorber) and with two additional control agents. Control 16 was similar to Controls 9-12, but included about 4.2 wt % active of the carboxylated CNTs. As such, Control 16 had the same amount of carboxylated CNTs as Ex. 4, but no PEDOT:PSS. Control 17 was similar to Controls 13-15, but included 0.5 wt % active of the PEDOT:PSS. As such, Control 17 had the same amount of PEDOT:PSS as Ex. 4, but no carboxylated CNTs.

The rheological and physical properties of Ex. 4 and the non-conductive agent were compared.

The apparent viscosity of Ex. 4 and the non-conductive agent (NCA) was measured at a shear rate ramp from 0.01 s⁻¹ to 100 s⁻¹ by a rotational rheometer (DHR-2, TA Instruments) with a parallel plate geometry of 40 mm in diameter. The results are shown in FIG. 5. Both Ex. 4 and the non-conductive agent exhibited shear-thinning behavior, but the viscosity of Ex. 4 was higher than that of the non-conductive agent, likely due to the larger size of the carboxylated CNTs and PEDOT:PSS compared to carbon black.

The surface tension and contact angle of Ex. 4 and the non-conductive agent were obtained by an optical tensiometer. The contact angles were measured on both a hot-pressed TPU film as well as on a glass substrate. The density of Ex. 4 and the non-conductive agent were determined by weighing (m) a given volume (V) of liquid using a balance, and then calculating the density: ρ=m/V. The viscosity, surface tension, contact angle, and density results are shown in Table 3.

TABLE 3

| | | Viscosity | Surface | Contact Angle | |
|---|---|---|---|---|---|
| | Density | @ 100 s⁻¹ | Tension | TPU film/ | |
| Agent ID | (g/cm³) | (mPa · s) | (mN/m) | Glass | Z |
| Ex. 4 | 1.053 | 11.0 | 41.8 | 78.8° ± 1.8°/ | 2.4 |
| | | | | 19.6° ± 4.3° | |
| Non-conductive | 1.067 | 5.5 | 30.5 | 54.7° ± 6.2°/ | 4.1 |
| Agent | | | | 19.2° ± 5.7° | |

Additional 3D objects were prepared as described in this example using the thermoplastic polyurethane build material, and Ex. 4, Control 16, or Control 17.

The mass fraction of the energy absorbers (carboxylated CNTs and PEDOT:PSS) in the additional example 3D object (i.e., the mass ratio of the energy absorber(s) to the printed part) was calculated by:

$$φ = \frac{{m}_{e a}}{{m}_{3 D Object}} .$$

The mass of the energy absorber(s) in the part (mₑₐ) can be expressed as:

$${m}_{cf} = A {D}_{x} {D}_{y} {m}_{d} p w n$$

where A is the cross-sectional area of the printed part; Dₓ and D_{y} are the resolution of droplet dispensing in the X and Y directions, respectively; m_{d} is the droplet mass (12 ng for the nozzle size of 16 μm) of the dispensed agent; p is the percentage of the nozzles used for the print job (80%); w is the mass fraction of the energy absorbers Ex. 4 (w_{CNT}˜4.2%, w_{PEDOT:PSS}˜0.5%); and n is the quantity of building layers.

The mass of the printed TPU part mₚ can be calculated by:

$${m}_{p} = ρ A n h$$

where ρ is the density of the TPU part (1.1 g/cm³), and h is the thickness of a build material layer (80 μm).

As a result, the mass fractions of the carboxylated CNTs and PEDOT:PSS in the additional 3D printed object were approximately 0.5 wt % and 0.06 wt %, respectively.

The additional 3D printed objects, respectively prepared with Ex. 4, Control 16, Control 17, or the non-conductive agent, had dimensions of 20 mm×10 mm×1 mm (length×width×thickness). Each 3D object was connected to a four-point collinear probe (Pro4, Lucas/Signatone) to obtain the volume resistance by a source meter (Keithley 2450, Tektronix Inc.) with a source current of 1 μA.

The electrical conductivity of the 3D object printed with Ex. 4 was 1.2×10⁻⁴ S/cm, while the 3D object printed with the non-conductive agent was 2.3×10⁻¹⁰ S/cm. The value of the 3D object printed with the non-conductive agent indicates that this 3D object exhibited electrically insulating characteristics. In comparison, the electrical conductivity of the 3D object printed with Ex. 4 was five orders of magnitude higher, and was within the range of typical conductive materials (>10⁻⁵ S/cm).

To evaluate the contribution of the individual energy absorbers to the conductivity of the 3D object printed with Ex. 4, the conductivity of each of the control 3D objects (generated with Control 16 and Control 17) was measured. The conductivity of the 3D objected printed with Control 16 (carboxylated CNTs, but no PEDOT:PSS) was 8.6×10⁻⁹ S/cm, and conductivity of the 3D objected printed with Control 17 (PEDOT:PSS, but no carboxylated CNTs) was <10⁻¹⁰ S/cm, which was out of the measurable range of the instrument. Both of control values suggested that the conducting networks of carboxylated CNTs and PEDOT:PSS were not formed. These results may also be indicative of insufficient energy absorption and underfused polymeric material (the TPU).

Overall, the results in Example 1 indicate that the addition of carboxylated carbon nanotubes into the multi-functional agent improves the fusion of the polymeric material in the build material composition, while the addition of PEDOT:PSS may create electrically connected bridges between the carboxylated CNTs, which facilitates more efficient travel of electrons in the 3D objects, resulting in high conductivity.

### Example 2

An example multi-functional agent with the same formulation as Ex. 4 from Example 1 was prepared. This agent is referred to as Ex. 18.

The non-conductive agent from Example 1 was also used in this example. This agent is again referred to the non-conductive agent.

Two ink cartridges, each with two printheads as described in Example 1, were filled with the Ex. 18 multi-functional agent. A third ink cartridge, having two printheads as described in Example 1, was filled with the non-conductive agent.

The build material composition was a commercially available thermoplastic polyurethane, namely ULTRASINT® TPU01 from BASF Corp. A layer (thickness 80 μm) of the build material composition was applied on the printer's build platform. The carriage scanning speed was set at 16 inches/second, and the droplet dispensing resolution was 600 dots per inch (DPI) in the X direction. At this speed and resolution, the firing frequency of droplets was 9.6 kHz. The desired agent was dispensed in accordance with one of the dispensing times shown in Table 4, where one or more of the printheads (PH) was activated in a first pass of the cartridge over the layer and zero or more of the printheads was activated in a second pass of the cartridge over the layer (back and forth in the X direction).

TABLE 4

| Dispensing | Pass 1 | Pass 2 |
|---|---|---|
| Time | (# active PH) | (# active PH) |
| 1 | 1 | 0 |
| 2 | 2 | 0 |
| 3 | 3 | 0 |
| 4 | 4 | 0 |
| 5 | 4 | 1 |
| 6 | 4 | 2 |
| 7 | 4 | 3 |
| 8 | 4 | 4 |

During dispensing, the build material composition and agent were also exposed to IR radiation from the lamps. The temperature of build material platform was maintained at 130° C. to 150° C. This process was repeated with multiple layers to form a 3D object of 1 mm thickness. The 3D object was 20 mm×10 mm (length×width). This process was performed for each of the agents. Three of each type of the 3D objects were printed. All of the objects were collected and cleaned by bead blasting.

In the following description, the notation “Agent×#” is used to identify the agent used during 3D printing and the dispensing time. This notation is also used to identify the 3D objects.

Three of the 3D objects printed according to the method described in this example were tensile bars—one half of which was printed with the Ex. 18 agent (Ex. 18×1) and the other half of which was printed with the non-conducting agent (NCA×1). These 3D objects are collectively referred to as Ex. 18×1-NCA×1.

The surface temperature on the build material platform was monitored by an infrared camera at three different stages—i) after spreading a new build material layer on a previously printed layer, ii) during the first pass of the cartridge(s) over the newly spread layer, and iii) during the second pass of the cartridge(s) on the newly spread layer. After applying the new layer of the build material (stage i), the surface temperature on top of the previous fused layer was around 120° C. When the carriage passed over the build area platform (pass 1, stage ii), the printheads respectively dispensed Ex. 18×1 and NCA×1 on the designated regions, and both the fusing lamps were on. The temperature of the build material coated with the non-conducting agent rapidly raised to a range of 125° C.-135° C., higher than that of the build material coated with the Ex. 18 agent, indicating that the radiation absorbing efficiency of the non-conducting agent was higher than that of the Ex. 18 agent in this stage. When the carriage scanned back (pass 2, stage iii), all the designated regions were further heated to a range of 140° C.-145° C. after the second-round radiation, resulting in complete build material fusion of the entire tensile bars.

The effect of agent dispensing times on the fusing temperature of the example parts (formed with Ex. 18 agent) was noted. A decrease in the average fusing temperature from 147.3° C. to 120.3° C. was observed with an increase in the dispensing times from one to eight. This decrease in temperature may be attributed to the increased heat loss by water evaporation.

All of the results set forth herein represent the average of three 3D objects.

The 3D objects were exposed to a tensile test. A tensile test with constant loading was conducted at a test speed of 10 mm/min, and another tensile test with cyclic loading was conducted by 1500 stretching-releasing cycles at a strain from 0% to 10% and a test speed of 60 mm/min.

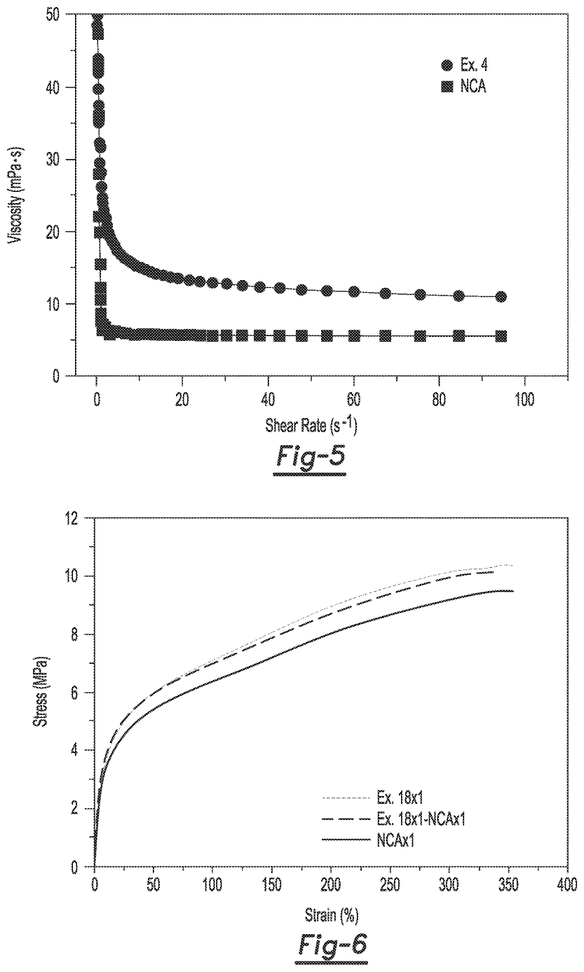

The tensile properties of the 3D objects formed with Ex. 18×1, NCA×1, and Ex. 18×1-NCA×1 were measured, and the results are shown in FIG. 6. All the parts exhibited high elasticity and toughness. In particular, the ultimate tensile strength (UTS) of the Ex. 18×1 3D object (10.2 MPa) and the Ex. 18×1-NCA×1 3D object (9.7 MPa) was higher than that of the NCA×1 3D object (9.5 MPa), suggesting that the conductive fillers of carboxylated carbon nanotubes and PEDOT:PSS reinforced the TPU objects. The fracture of the Ex. 18×1-NCA×1 3D object was not at the interface between the two halves, indicating strong interface bonding. These results indicate that the multi-functional agent is capable of fabricating mechanically strong 3D objects.

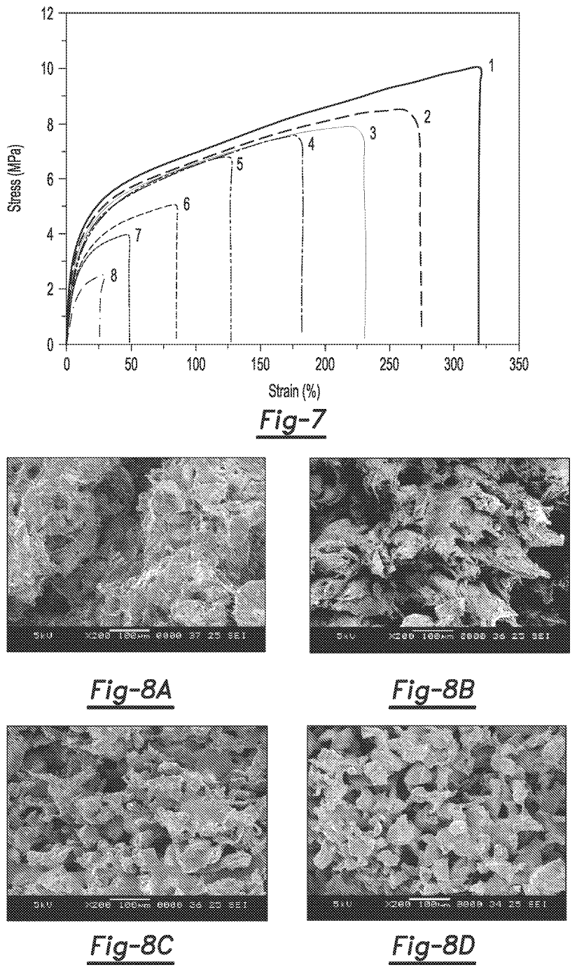

The tensile properties of the 3D objects formed with the Ex. 18 agent at various dispensing times were also tested. These results are shown in FIG. 7. With the increase in the Ex. 18 agent dispensing times from one to eight, the tensile performance of the 3D objects correspondingly degraded. Excessive fillers can interrupt the continuity of the polymer matrix, and thus degrade the mechanical properties of the fabricated 3D objects.

Fractographs of some of the 3D objects fabricated with the Ex. 18 agent were observed by a scanning electron microscope (JSM-5600 LV, JEOL). In particular, the SEM images of the objects formed with Ex. 18 dispensed one time (Ex. 18×1 3D object), three times (Ex. 18×3 3D object), five times (Ex. 18×5 3D object), and seven times (Ex. 18×7 3D object) are shown, respectively in FIG. 8A through FIG. 8D. The quantity of unfused powder particles appeared to increase with the agent dispensing times, leading to an increase in porosity.

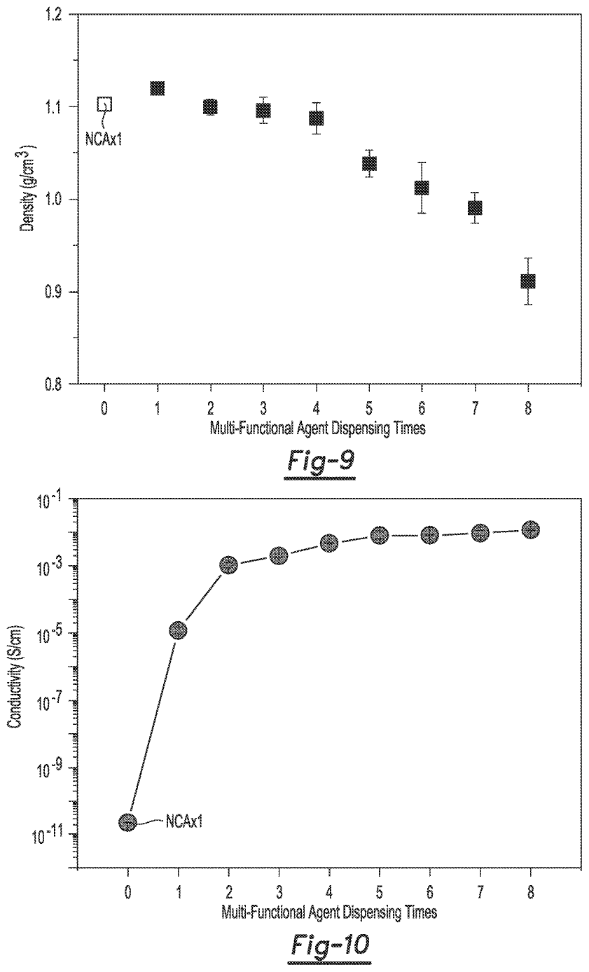

The density of the 3D objects fabricated with the non-conducting agent and with the Ex. 18 agent at various dispensing times was measured by an analytical balance (XS204, Mettler). The results are shown in FIG. 9. The measured densities confirmed that the 3D objects formed with more dispensing times exhibited higher porosity. The Ex. 18×1 3D object had slightly higher densities than the NCA×1 3D object, possibly because the addition of the carboxylated carbon nanotubes and PEDOT:PSS effectively reduced the porosity of the 3D object.

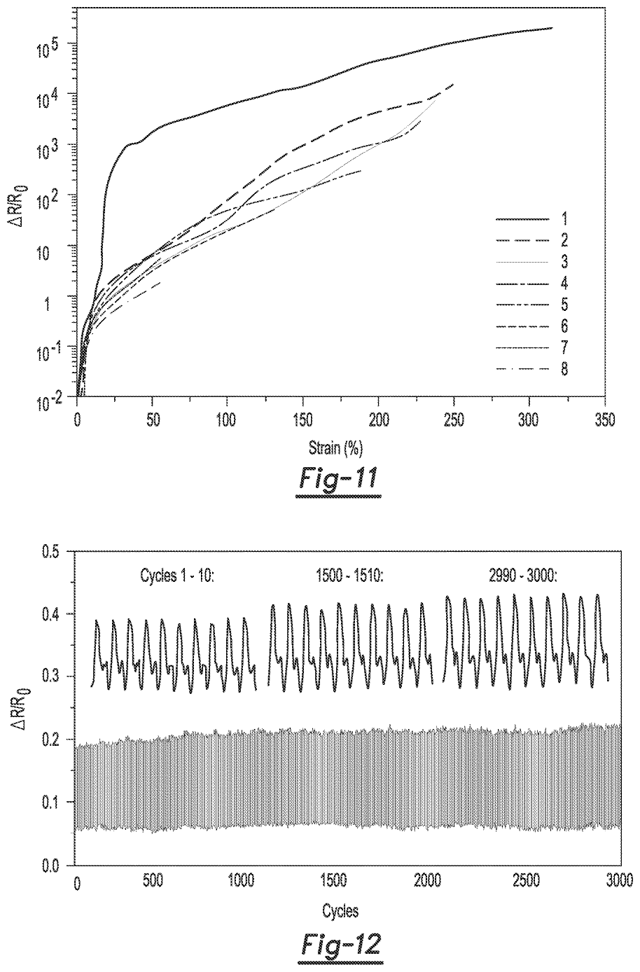

Each of the Ex. 18×1 through Ex. 18×8 3D objects and the NCA×1 3D object was connected to a four-point collinear probe (Pro4, Lucas/Signatone to obtain the volume resistance by a source meter (Keithley 2450, Tektronix Inc.) with a source current of 1 μA. The results are shown in FIG. 10, which plots conductivity as a function of Ex. 18 agent dispensing time. These results indicate that by controlling the conductive filler content through changing the dispensing times, the electrical conductivity across a printed 3D object can be precisely tailored. The conductivity of the NCA×1 3D object was 2.3×10⁻¹⁰ S/cm, indicating the electrical insulating characteristic. The conductivity of the Ex. 18×1 3D object (1.2×10⁻⁴ S/cm) was improved by six orders of magnitude compared with that of NCA×1 3D object, reaching the range of typical conductive materials (>10⁻⁵ S/cm). The suddenly elevated conductivity is caused by percolation transition, above which continuous electron paths or conducting networks are formed. A further increase in the Ex. 18 agent dispensing times resulted in the slow increment in conductivity that approached a maximum value of 0.12 S/cm for the Ex. 18×8 3D object. The result in FIG. 7 and FIG. 19 indicate that the Ex. 18×6 3D object achieved a good balance between the electrical conductivity and mechanical properties.

To illustrate the conductivity difference between the two halves of an Ex. 18×6-NCA×1 3D object, a light-emitting diode (LED) lighting test was conducted. The Ex. 18×6-NCA×1 3D object was built in the same manner as Ex. 18×1-NCA×1 3D object, except that the Ex. 18 agent was dispensed using dispensing time 6 in Table 4. In the LED lighting test, the Ex. 18×6-NCA×1 3D object and an LED indicator were connected to a DC 3 V power supply. When the NCA×1 was connected to the circuit, the LED indicator was deactivated. In contrast, the LED indicator lit up when the Ex. 18×6 was connected instead.

To investigate the sensitivity of the part for strain sensing applications, the piezoresistive response of the Ex. 18 3D objects was tested. Two small strips of copper foils were stuck on the parts by silver adhesive (CW2460, Chemtronics) and each gripped by an alligator clip of the source meter. The copper foils also served as the gauge marks for the parts. The piezoresistive properties were characterized under constant and cyclic loadings. FIG. 11 shows the normalized resistance change ΔR/R₀ as a function of strain for the Ex. 18 3D objects printed various Ex. 18 agent dispensing times during constant stretching. Here, ΔR is the change in resistance at any instance of deformation, and R₀ is the initial resistance. The variation of ΔR/R₀ with strain e for all of the 3D objects was slow in the beginning and then became exponential at high e because the tunnel distance between fillers was increasing, corresponding to the nonlinear region in the piezoresistive response. The gauge factor, which is the gradient of the plot of ΔR/R₀ against E, was used as a key parameter for evaluating the sensitivity of strain sensors. Among all the Ex. 18 3D objects, the Ex. 18×1 3D object exhibited the highest sensitivity across a wide range, with a maximum gauge factor of 2119. To evaluate the repeatability of the piezoresistive response of the Ex. 18×1 3D object, a cyclic test was conducted under prolonged repetitive strains of 10% by 3000 stretching-releasing cycles. These results are shown in FIG. 12, illustrating ΔR/R₀ as a function of time. 3000 stretching-releasing cycles were recorded after 500 warm-up cycles, a significantly stable variation in the resistance was obtained.

### Example 3

A strain sensor similar to that shown in FIG. 3 was 3D printed according to the method described in Example 2. The sensing layer (sensor 46) was printed using TPU and Ex. 18×1 (see Example 2) and the insulating ring-shaped frame (band 44) was printed using TPU and NCA×1 (see Example 2).

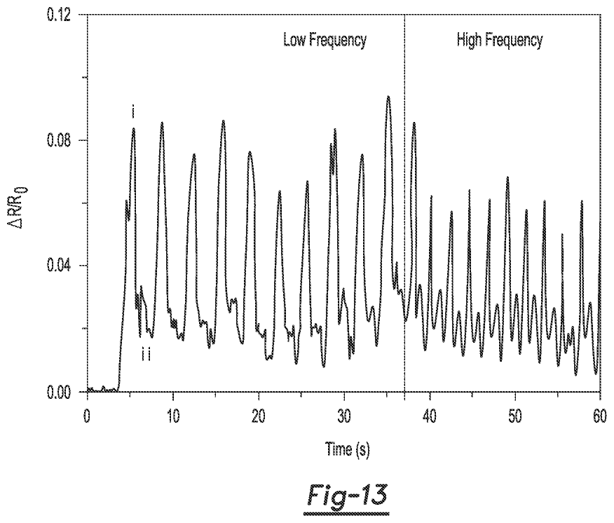

The piezoresistive responses of the strain sensor to periodic finger motions were measured for 10 cycles under frequencies of 3.0 Hz (low frequency) and 4.5 Hz (high frequency), respectively. The results are shown in FIG. 13, illustrating ΔR/R₀ as a function of time. The bending of the finger induced an increase in ΔR/R₀, and the higher frequency resulted in a lower peak value of ΔR/R₀. The repetitive bending caused a periodic and stable resistance response, indicating the excellent stability of the sensor.

### Example 4

In this example, a polyamide 12 powder (HP 3D High Reusability PA 12) was used as the build material composition. The Ex. 18 agent was used as the multi-functional agent, and 3D object were printed using dispensing times 1 and 2 of Table 4. Because polyamide 12 has a higher melting point than the lowest melting temperature of the thermoplastic polyurethane used in the other examples, the power of the overhead and fusing lamps was raised to enable a higher fusing temperature (e.g., from about 197° C. to about 198° C.) to be achieved. Polyamide 12 3D objects were successfully printed with the multi-functional agent.

It is to be understood that the ranges provided herein include the stated range and any value or sub-range within the stated range, as if the value(s) or sub-range(s) within the stated range were explicitly recited. For example, a range from about 2 wt % to about 18 wt %, should be interpreted to include not only the explicitly recited limits of from about 2 wt % to about 18 wt %, but also to include individual values, such as about 2.75 wt %, 8 wt %, 14 wt %, 15.5 wt %, etc., and sub-ranges, such as from about 5 wt % active to about 15 wt % active, from about 3 wt % active to about 17 wt % active, from about 2 wt % active to about 14 wt % active, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A multi-functional agent for three-dimensional (3D) printing, comprising:
carboxylated carbon nanotubes present in an amount ranging from about 0.5 wt % active to about 5.0 wt % active based on a total weight of the multi-functional agent;
poly(3,4-ethylenedioxythiophene) polystyrene sulfonate (PEDOT:PSS) present in an amount ranging from about 0.1 wt % active to about 0.8 wt % active based on the total weight of the multi-functional agent;
a co-solvent; and
a balance of water.

2. The multi-functional agent as defined in claim 1, wherein a total wt % active of the carboxylated carbon nanotubes and the PEDOT:PSS in the multi-functional agent is less than 5.5 wt % active.

3. The multi-functional agent as defined in claim 1, wherein:
the carboxylated carbon nanotubes are present in an amount ranging from about 0.5 wt % active to about 5 wt % active based on the total weight of the multi-functional agent; and
the PEDOT:PSS is present in an amount of about 0.25 wt % active based on the total weight of the multi-functional agent.

4. The multi-functional agent as defined in claim 1, wherein:
the carboxylated carbon nanotubes are present in an amount ranging from about 0.5 wt % active to about 4.25 wt % active based on the total weight of the multi-functional agent; and
the PEDOT:PSS is present in an amount of about 0.5 wt % active based on the total weight of the multi-functional agent.

5. The multi-functional agent as defined in claim 1, wherein:
the carboxylated carbon nanotubes are present in an amount ranging from about 0.5 wt % active to about 3 wt % active based on the total weight of the multi-functional agent; and
the PEDOT:PSS is present in an amount of about 0.75 wt % active based on the total weight of the multi-functional agent.

6. The multi-functional agent as defined in claim 1, further comprising a non-ionic surfactant present in an amount ranging from about 0.1 wt % active to less than 5 wt % active based on the total weight of the multi-functional agent.

7. The multi-functional agent as defined in claim 1, wherein the co-solvent is present in an amount ranging from about 10 wt % active to about 20 wt % active based on the total weight of the multi-functional agent.

8. The multi-functional agent as defined in claim 1, wherein the multi-functional agent is free of aggregates of the carboxylated carbon nanotubes and the PEDOT:PSS.

9. The multi-functional agent as defined in claim 1, wherein the carboxylated carbon nanotubes and the PEDOT:PSS are infrared energy absorbers, and wherein the multi-functional agent excludes other infrared energy absorbers.

10. A three-dimensional (3D) printing method, comprising:
spreading a polymeric build material composition to form a build material layer;
based on data derived from a digital 3D object model, selectively applying a multi-functional agent to at least a portion of the build material layer, the multi-functional agent including:
carboxylated carbon nanotubes present in an amount ranging from about 0.5 wt % active to about 5.0 wt % active based on a total weight of the multi-functional agent;
poly(3,4-ethylenedioxythiophene) polystyrene sulfonate (PEDOT:PSS) present in an amount ranging from about 0.1 wt % active to about 0.8 wt % active based on the total weight of the multi-functional agent;
a co-solvent; and
a balance of water; and
exposing the build material layer to infrared radiation to coalesce the build material composition in the at least the portion, thereby forming a layer of a 3D object.

11. The method as defined in claim 10, wherein:
prior to exposing the build material layer to the infrared radiation, the method further comprises selectively applying a liquid functional agent to at least another portion of the build material layer;
the at least the portion patterned with the multi-functional agent forms a conductive portion of the layer of the 3D object; and
the other portion patterned with the liquid functional agent forms an insulating portion of the layer of the 3D object.

12. The method as defined in claim 10, wherein the selective application of the multi-functional agent involves selectively applying the multi-functional agent according to a dispensing time, wherein the dispensing time is achieved by:
activating at least one of a plurality of printheads to dispense the multi-functional agent in a first pass of the plurality of printheads over the build material layer; and
one of:
i) inactivating all of the plurality of printheads in a second pass of the plurality of printheads over the build material layer; or
ii) activating at least one of a plurality of printheads to dispense the multi-functional agent in the second pass of the plurality of printheads over the build material layer.

13. The method as defined in claim 12 wherein the dispensing time includes one of eight dispensing times, and wherein:
in a first dispensing time, one of the plurality of printheads is activated in the first pass of the plurality of printheads over the build material layer and all of the plurality of printheads are inactivated in the second pass of the plurality of printheads over the build material layer; or
in a second dispensing time, two of the plurality of printheads are activated in the first pass of the plurality of printheads over the build material layer and all of the plurality of printheads are inactivated in the second pass of the plurality of printheads over the build material layer; or
in a third dispensing time, three of the plurality of printheads are activated in the first pass of the plurality of printheads over the build material layer and all of the plurality of printheads are inactivated in the second pass of the plurality of printheads over the build material layer; or
in a fourth dispensing time, four of the plurality of printheads are activated in the first pass of the plurality of printheads over the build material layer and all of the plurality of printheads are inactivated in the second pass of the plurality of printheads over the build material layer; or
in a fifth dispensing time, four of the plurality of printheads are activated in the first pass of the plurality of printheads over the build material layer and one of the plurality of printheads is activated in the second pass of the plurality of printheads over the build material layer; or
in a sixth dispensing time, four of the plurality of printheads are activated in the first pass of the plurality of printheads over the build material layer and two of the plurality of printheads are activated in the second pass of the plurality of printheads over the build material layer; or
in a seventh dispensing time, four of the plurality of printheads are activated in the first pass of the plurality of printheads over the build material layer and three of the plurality of printheads are activated in the second pass of the plurality of printheads over the build material layer; or
in an eighth dispensing time, four of the plurality of printheads are activated in the first pass of the plurality of printheads over the build material layer and four of the plurality of printheads are activated in the second pass of the plurality of printheads over the build material layer.

14. A three-dimensionally (3D) printed article, comprising:
coalesced polymeric build material, wherein at least a portion of the coalesced polymeric build material is electrically conductive and includes intermingled therein:
carboxylated carbon nanotubes in an amount ranging from about 0.01 wt % to about 10 wt % based on a total weight of the 3D printed article; and
poly(3,4-ethylenedioxythiophene) polystyrene sulfonate (PEDOT:PSS) in an amount of about 0.01 wt % to about 1 wt % based on the total weight of the 3D printed article.

15. The 3D printed article as defined in claim 14, wherein another portion of the coalesced polymeric build material is electrically insulating.
